(19) United States
(12) Patent Application Publication
(10) Pub. No.: US 2004/0128163 A1
(43) Pub. Date: Jul. 1, 2004

(54) Health care information management apparatus, system and method of use and doing business

(76) Inventors: Philip Holden Goodman, Reno, NV (US); Sven Erling Inda, Crestview Hills, KY (US)

Correspondence Address: NATH & ASSOCIATES, 1030 15th STREET, 6TH FLOOR, WASHINGTON, DC, 20005, US

(21) Appl. No.: 10/456,325

(22) Filed: Jun. 5, 2003

Related U.S. Application Data
(60) Provisional application No. 60/386,282, filed on Jun. 5, 2002.

(51) Int. Cl. G06F 17/60

(52) U.S. Cl. 705/2

(57) ABSTRACT

A set of coupled computerized systems with methods that can allow a health care practitioner preferably to track clinical data about a patient, to link diagnostic and procedural code charges at the point of care, and to exchange such data with clinicians responsible for the cross-coverage of management responsibilities. Data may be captured on handheld computer devices (or directly by an Internet or client application) and transmitted to a coupled web server which warehouses and distributes data elements to the billing office of the practitioner. The web server may provide additional functionality for moving patient data, such as demographic, medication, and evaluation records, between office-based computer systems and the handheld. Hospital-managed data systems with Internet viewing permissions may also be queried for web server-effectuated transfer of patient data to the handheld device to augment clinical care and charge capture. Identifier-free data may be aggregated across multiple health care practitioners participating in the system, so that their administrative and clinical performance may be compared to others of the same specialty or in the same geographic region. Data on and between platforms may be encrypted and an audit trail may be generated in compliance with federal standards.

### CROSS REFERENCE TO RELATED APPLICATIONS

This application claims priority through and continues the applicants' prior provisional application entitled Health Care Information Management System and Methods of Use and Doing Business, Ser. No. 60/386,282, filed Jun. 5, 2002, which provisional application this application hereby incorporates by reference.

### FIELD OF THE INVENTION

This invention is relates to apparatus, systems, and methods of automated data collection by medical personnel. More specifically, this invention relates to data collection of medical activities or patient encounters by health care personnel, preferably at the point-of-care and by capturing, transmitted, or otherwise manipulating the resulting data by a system comprised of computing devices such as handheld personal digital assistants (PDAs), personal computers, and hosted Internet services.

### BACKGROUND OF THE INVENTION

Despite the advent of computer technology, there has been virtually no change in the process by which physicians and other health care providers personally account for professional services rendered, and the manner in which this information is transferred to their billing managers to generate insurance and patient billing. After evaluating treating a patient in the medical office, the physician typically checks a box on an encounter form to indicate the intensity of the evaluation and management (E&M) services provided, likewise indicates any procedures performed, and writes in a rank-ordered listing of several diagnoses assigned to the patient corresponding to those services. The encounter form is typically carried by the patient to front office personnel who later submit the form to those responsible for billing the insurance carrier and possibly the patient as copayor. Although not automated, this office setting enables nursing and administrative staff to oversee the process of “charge capture”, so that omissions, incompleteness, or inconsistencies are generally detected in real time, and all charge sheets are virtually certain to reach their destination.

In the case of patients seen in the hospital, there is a disruption of the above-mentioned oversight. The physician is the sole emissary of the practice, responsible for documenting what patients were seen, what level of E&M services, and what medical or surgical procedures were provided for specific diagnoses. Because the hospital is a separate legal entity, it cannot be engaged in oversight of the physicians billing. The ability to bill an insurance carrier and patient for E&M and procedures performed therefore depends entirely on the reliability and availability of the physician to (1) document which patient was seen, including unique identifiers and demographic data about newly evaluated patients, (2) the level of E&M services provides, (3) any procedures performed, and (4) rank-ordered diagnoses corresponding appropriately to the above E&M and procedures.

Most hospital-practicing physicians keep a hand-written or office-typed list of patients according to room number and name, and jot remarks in the adjacent spaces. For new patients, most physicians try to obtain a “face” sheet from the hospital chart which contains identifiers and demographic information needed for the billing process. At some intervals (typically every several days to several weeks) the physician delivers the accumulated rounding forms and face sheets to the practice office for submission to billing personnel. In some practices, the physicians are so unreliable that office personnel must contact the physician personally each day to ask what patients were seen and what was done, and in others the office staffjust wait until a patient is discharges to receive a copy of the dictated hospital summary which they use to retrospectively impute on what days the patient was seen and what was done.

The result is that substantial fraction of charges typically are either not submitted at all, incompletely submitted, or submitted after long delays. In this event, unsubmitted charges are lost forever to the practice. Incomplete charges must either be reconciled retrospectively by educated guesses on the part of the billing staff (occasionally by contact with the doctor, although this can be difficult to do on a regular basis) or intentionally undercoded to avoid scrutiny by the insurance carrier. Delayed charges result in loss of the time value of money to the practice.

Generally speaking, handheld computers, such as “personal digital assistants” (PDAs), have enabled individuals to track tasks to be done and access contact information. Data on prior art PDA's has been routinely synchronized with a personal computer using a cable or infrared or wireless linkage.

In the field of PDA-based charge capture, there are products such as those from Allscripts (“Touchworks”; Libertyville, Ill.; www.allscripts.com), IMRAC (“Pocket Patient Billing”; Nashville, Tenn.; www.imrac.com), Ingenious Med Inc. (“Imbills”; Atlanta, Ga.; www.ingeniousmed.com), MDeverywhere (Durham, N.C.; www.mdeverywhere.com), MedAptus (Boston, Mass.; www.medaptus.com), Medical Manager Health Systems (“Ultia”; Tampa, Fla.; www.medicalmanager.com), PatientKeeper (“ChargeKeeper”; www.patientkeeper.com; Brighton, Mass.), and several “applets” that run on the database software by DDH Software (Lake Worth, Fla.; www.ddhsoftware. com).

The products by Allscripts, MDeverywhere, MedAptus, Medical Manager, and PatientKeeper are essentially electron versions of the office-encounter paper described above, intended to be used as part of a larger computer-based management system or suite of applications. Their web sites (above) indicate that their design is primarily targeted for single-day contacts during office-based charge capture. They do not provide a stand-alone electronic medical record system for the period of potential hospitalization, nor features for managing rounds, tasks to be done, nor synchronization with any personal computer, nor general Internet transmittal of charge data.

The products by IMRAC and Ingenious Med Inc. are self-contained applets running on off-the-shelf forms software. As such, they can be used to track patients over a period of days, but the need to navigate across many form pages obviates the time savings a PDA-based charge capture device should represent. For instance, both of these applets require the user to enter seven screen taps in order to repeat on an identical charge to that of the day prior for a hospitalize patient. In addition, neither of these applets provides for Internet transmittal of data, hosting, or delivery. Neither provided for distribution of information or instruction via the Internet to cross-covering colleagues. The forms-software interface also limits the ability to represent in compact and color-coding information necessary for efficient and comprehensible rounding during the course of hospital practice.

U.S. patent application Ser. No. 09/967,210 entitled “Real-time access to health-related information across a network”, filed Sep. 28, 2001, focused on the transmission of health care data over tradition medical computing systems but only vaguely described the role of a handheld device as a component.

U.S. patent application Ser. No. 10/116,919 entitled “Method and apparatus for introducing medical necessity policy into the clinical decision making process at the point of care”, filed Oct. 10, 2002, no patent issued. This application focused on the use of a PDA as part of an automated point-of-care system to check that the choice of diagnosis code and procedure code conform with policy rules.

Prior art processes are also shown in FIG. 1A. This process includes a method 101 in which a clinician becomes aware of which patients he or she will visit in the office or hospital. The most common methods are believed to include the physician's use of a hand-written sheet of paper or pocket-sized index card, adding and deleting listings over the course of day. An office staff member may print a daily list of patients for the physician's use, which the clinician often obtains either the day prior or on day of services to be rendered.

As the clinician performs evaluation and management and/or other procedural services, he or she typically uses a pen to indicate the patient was seen 102, possibly adding notations about the level or intensity of service and procedures performed that day; the constraints of time severely limit the completeness, accuracy, and legibility of such records. The aforementioned paper documents typically accumulate over a period of days or sometimes week, at which time, if not misplaced, the clinician delivers, telephones, or faxes such documents 103 to the billing manager designated to process such charges.

The billing manager then interprets the hand-written notations as best as possible, occasionally with the object of contacting the clinician for clarification or to send a staff member to review clinical chart records to obtain adequate documentation (especially to ensure proper linkages of ICD diagnostic, CPT procedural, and referring physician codes), then hand-enters 104 a best estimate of appropriate charge information into a local billing system, usually computer-based.

The billing manager likewise collects and cleans demographic data about the patient 106, either from the patient or existing office record system, or, in the case of a hospital, by obtaining written printout, fax, or Internet-accessed copy of such information, commonly referred to as the “face sheet”.

Finally, the billing manager combines the cleaned demographic and confirmed charge sets to generate 107 (usually using an electronic computer system and program designed for that purpose) bills that are sent to the insurance company and, for residual payment due, mailed to the patient.

### BREIF SUMMARY OF THE INVENTION

Accordingly, the present invention provides apparatus, a system, or a method for automated collection of data, and most preferably patient management and treatment activities, in the medical field and, most preferably in the hospital, medical office, or similar setting. It may also provide related business methods.

The present invention preferably provides one or more of: (a) coupled portable and Internet-based computer system to exchange and make universally available clinical and billing information ascertained at the point of care, (b) intuitive interfaces for the intended type of users of the portable and Internet-based computer systems, (c) portable device and Internet-based exchange of patient data sets among colleagues for the purpose of cross-covering those patients when the primary clinician is not available, and/or (d) enforcement of certain rules to prevent errors in demographic data or linkages among charge codes that would otherwise lead to delayed or rejected insurance claims.

This invention preferably comprises not only the implementation of portable and Internet server-based data collection, exchange, and analytic systems and methods, but the novel coupling of such systems so as to alter and improve the practice style and billing collection efficacy of medical practices.

The invention preferably targets hospital and other settings wherein the clinician operates remote from an established office system comprised of staff members and electronic data capture system that would minimize the rate of errors in coding and delays in submission of claims; however, the preferred system and methods are readily adaptable to office and clinical research settings wherein the desirable attributes performed by this invention may lead to reduced office overhead costs.

The present invention also preferably consists of a processor, wherein the information stored in the memory includes instructions for execution by the processor, and wherein the information also includes data that represents the rules for proper linkage of diagnostic and procedural codes required for payment approval from at least one health care payer in connection with the encounter.

In addition, the present invention preferably consists of an web server comprising a processor, electronic memory and systems to back up the memory, wherein the information stored in the memory includes instructions for execution by the processor, and wherein the information also includes software instructions for the processing, storage, and transfer of data by way of electronic ports connected to the Internet.

Another aspect of the present invention preferably consists of a client device comprises a processor, wherein the information stored in the memory includes instructions for execution by the processor, and wherein the information also includes instructions to communicate as a client with an Internet-connected server. The aforementioned device preferably portable is adapted to exchange data with the aforementioned web server system by means of device-to-local Internet-connected computer synchronization, usually implemented through a docking cradle (but potentially by local infrared or radio-frequency local or wide area network transceivers). The preferred implementation of such portable devices is in such physical size as to be transportable in a standard shirt or jacket pocket, and to fit in the palm of one hand for operation with a stylus in the other hand, or by activation of a small keypad by the thumb of the same hand.

The portable device may operate under the control of any computer programming language, as the functionality is not specific to any hardware device. Preferably essentially the same user interface and functionality as provided in the portable device is embodied in this invention on the Internet (or VPN) server system itself, preferably as a convenience to those user who prefer not to use a small-footprint device, or who operate in environments wherein is may occasionally be easier to enter data directly onto a larger computer screen and subsequently download such elements to the portable device for use at the point of patient care.

The portable device preferably is programmed to provide an interface that mimics the visually and cognitive flow of transactions that occur during the course of care of a patient. The portable device preferably is programmed with rules relevant to completeness of administrative data, allowable and required linkages among diagnostic and procedural codes and names of referring clinicians, and allowable associations of code modifiers.

The portable device preferably enables the user to wirelessly transfer certain information to colleagues responsible for cross-covering the patients during hours when the primary clinician will not be available. The portable device also preferably enables the user to locally print a charge report for delivery to the practitioner's billing office. In addition, the portable device preferably enables the user to locally print a progress note that may be signed and placed within a hospital or office chart to serve as documentation of the effort expended in care that day.

Most preferably, the portable device tracks charges entered by the user and transmits this information to a local computer to which it is synchronized, from which the information is automatically uploaded to a coupled Internet-based server system. Preferably, the portable device is quipped with direct Internet or VPN access capability and can directly transmit the charge information to a coupled Internet (or VPN)-based server system.

In this manner, patient administrative data may be directly accessed from an office or hospital database system and, using the Internet (or VPN)-server system as an intermediary host, downloaded to the portable device. Downloaded patient administrative data may be acquired from the office or hospital system either indirectly by “copy and paste” operations between computer monitor window (possibly by use of a macro program to automate such operations), by client-side parsing of the hypertext content representing the office or hospital data, or by direct file transfer protocols whereby electronic handshaking, authentication, and interchange of data elements takes place.

Software on the portable device preferably is programmed to reconcile any pre-existing, potentially incomplete or erroneously administrative data entered manually on the portable device. Preferably, patient administrative, clinical, and charge reports may be uploaded to the coupled Internet-based server and entered into an office database system by the same direct and indirect methods mentioned above.

Preferably, the uploaded reports, upon arriving at the Internet (or VPN)-based server, preferably result in automated e-mail messaging to a designated office staff member, in which message is contained an Internet link that, when selected, caused a client browser to activate and access the Internet server system; upon authentication, the office staff member initializes the download of reports into the office-based system.

The Internet-connected server preferably provides practice administrators with analytic functions (“analytics”) that can be used to maintain quality control in the processes of patient care and billing of medical charges, including comparisons using data stripped of identifying information; such comparison may include but are not limited to one or more of the following by way of textual and/or graphic displays: (a) temporal trends of billing code levels for new and established patients, by billing clinician, compared with other clinicians in practice and other groups in same specialty and or by diagnosis, (b) cumulative diagnosis code mixtures by billing clinician, compared with other clinicians in practice and other groups, (c) timeliness of charge report submission, to detect patterns of gaps with real-time notification of administrative staff upon the occurrence of gaps unanticipated by historical patterns and pre-set alarm values, (d) length of hospital stay, or number of office visits within a specified window of time, of a clinician user's patients as a function of diagnoses, severity of illness measures, medical specialty and demographics of the clinician, and geographic region, and (e) office or hospital drug prescribing patterns of a clinician user's patients as a function of diagnoses, severity of illness measures, medical specialty and demographics of the clinician, and geographic region.

The “analytics” methods additionally preferably provide an interface for administrative entry of certain insurance payer reimbursement and contractual information by a practice, for analytic comparison of such performances with that of similar practices in the same region and across multiple regions served by that payer; comparisons are made using a database generated from similar payer information from other practices stripped of practice and patient identifying information. Industry-standard or other encryption preferably is applied to patient- and practice-related data stored on portable, local computer, and Internet devices, as well as to data transmitted electronically over local wireless and Internet networks; such encryption may be a combination of private and public-key methods as suited to the communication system.

The present invention is more specifically described in the following paragraphs by reference to the drawings attached only by way of example. Other advantages and novel features of the invention will become apparent from the following descriptions and claims.

It therefore is to be understood that the invention is to be determined by the scope of the claims as issued and not by whether any given subject matter provides every feature or advantage or overcomes every disadvantage in the prior art noted above.

### BRIEF DESCRIPTION OF THE DRAWINGS

The preferred embodiments, and certain prior art, of the present invention are shown in the accompanying drawings. The drawings are not necessarily drawn to exact scale; emphasis instead placed on teaching the systems and methods of the invention. All names are fictitious.

FIG. 1A is the prior art sequence of events in the daily workflow of a doctor, leading to the capture and billing of procedural charges for hospitalized patients (office and clinical research site flow would be similar).

FIG. 1B is the sequence of events in the daily workflow of a doctor, leading to the capture and billing of procedural charges for hospitalized patients (irrespective of site of care), in accordance with the principles of a preferred embodiment.

FIG. 2 is a block diagram indicating the conceptual components of the coupled Internet and portable device systems for data acquisition, communication, and retrieval system according to an embodiment of the present invention.

FIG. 3A is a schematic view of one type of portable device that may be used in conjunction with the preferred embodiment.

FIG. 3B presents a side view of the portable device of FIG. 3A.

FIG. 4 contains screenshots of one instantiation (called “eHospitalist” and also called “modeMD” in the attached Appendix A) of the preferred embodiment showing that upon tapping the icon on the main graphic screen of the portable device, the user periodically enters an authenticating password, after which the main “active rounding” view is displayed.

FIG. 5 consists of screenshots of one instantiation of the preferred embodiment showing alternative views of patient lists, and how tapping a menu item accesses these lists.

FIG. 6 is a screenshot of one instantiation of the preferred embodiment showing details of the functionalities of an active rounding view.

FIG. 7 consists of screenshots of one instantiation of the preferred embodiment showing alternative views resulting from taps on the upper tabs, and third-order views resulting from taps on the “chart view” bottom tabs; individual views are described in detail below.

FIG. 8 consists of screenshots of one instantiation of the preferred embodiment showing the display of charges that have been entered by the user, but not yet reported; linked dialogs resulting from taps on the indicated tabs demonstrate filtering, immediate report generation with annotation for the billing administrator, and the ability to immediately print a report to an infrared-equipped printer.

FIG. 9 consists of screenshots of one instantiation of the preferred embodiment showing the simultaneous display of active diagnoses or problems (with linked new diagnosis screen), most resent visit code combination (with option to duplicate with a single tap, or enter the new visit screen), and most recent non-evaluative procedure code combination (with option to tap to link to the new procedure screen); two types of coding rules are shown enforced.

FIG. 10 is a screenshot of one instantiation of the preferred embodiment showing the administration view of the chart tab (see also FIG. 7); demographic, geographic, and clinical data elements are entered, either manually or by download from the Internet server system.

FIG. 11 is a screenshot of one instantiation of the preferred embodiment showing the history and physical documentation view of the chart tab (see also FIG. 7); elements are entered either manually or by download from the Internet server system.

FIG. 12 is a screenshot of one instantiation of the preferred embodiment showing the drug prescribing view of the chart tab (see also FIG. 7); elements are entered either manually or by download from the Internet server system.

FIG. 13 consists of screenshots of one instantiation of the preferred embodiment showing the progress note, or SOAP, view of the chart tab (see also FIG. 7); elements are entered manually and are uploaded to the Internet server system to accompany charge reports; a SOAP note may be printed by infrared transmission to a printer, or from another computer at the time of synchronization.

FIG. 14 consists of screenshots of one instantiation of the preferred embodiment showing the discharge note view of the chart tab (see also FIG. 7); elements are entered manually and are uploaded to the Internet server system to accompany charge reports; a discharge note may be printed by infrared transmission to a printer, or from another computer at the time of synchronization, to be given to the patient.

FIG. 15 consists of screenshots of one instantiation of the preferred embodiment showing the to-do listing view of the chart tab (see also FIG. 7); elements are entered manually and cause to appear an associated color icon on the rounding view screen (FIG. 6); to-do items may be immediate (black icon), future-timed (red), assigned to a cross-covering colleague (X), or communicated from someone through the Internet server system or from the operating system (question marks of various colors).

FIG. 16 consists of screenshots of one instantiation of the preferred embodiment showing a world-wide web page hosted by the Internet server of the preferred embodiment, for the purpose of extracting accurate administrative data from a hospital or office system whose web page is likewise hosted by an Internet server.

FIG. 17 is a screenshot of one instantiation of the preferred embodiment showing a world-wide web page hosted by the Internet server of the preferred embodiment, representing the authentication process whereby a billing administrator may access charge information previously uploaded from a portable device (see also FIG. 18).

FIG. 18 is a screenshot of one instantiation of the preferred embodiment showing a world-wide web page hosted by the Internet server of the preferred embodiment, representing the process whereby a billing administrator may download reports in any number of formats to the office billing system.

FIG. 19 is a screenshot of one instantiation of the preferred embodiment showing a world-wide web page hosted by the Internet server of the preferred embodiment, representing the process whereby a an office administrator analyze the performance of the clinicians and insurance payers.

### DETAILED DESCRIPTION OF THE PREFERRED EMBODIMENTS

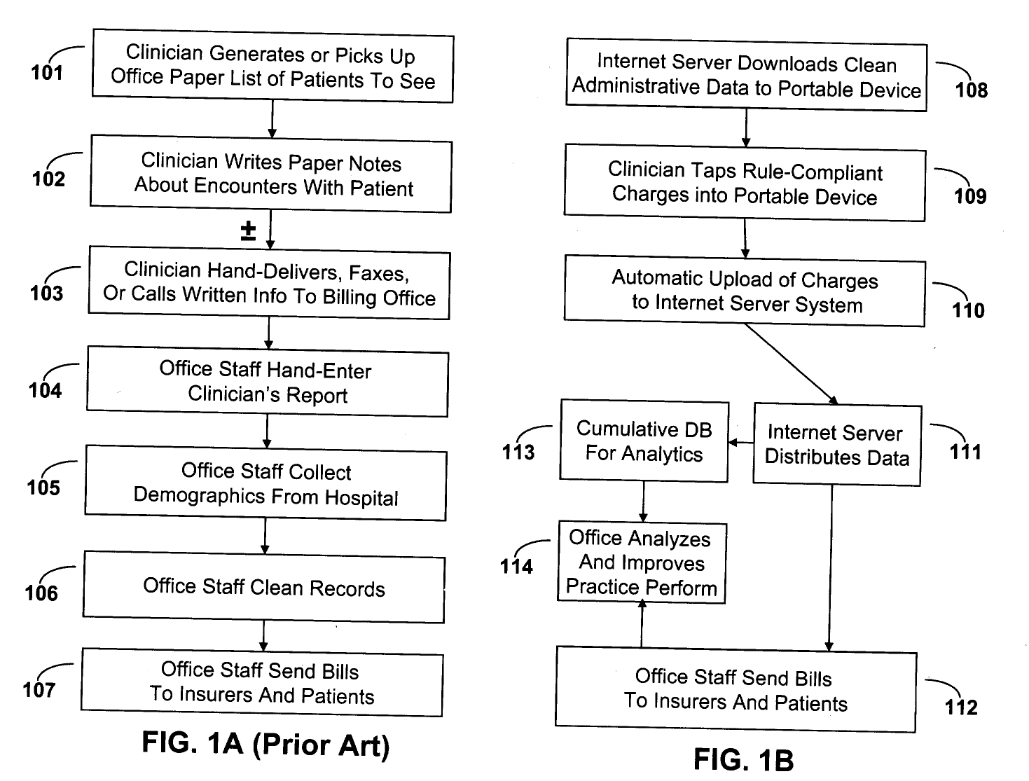

The preferred embodiments of the present invention are described below by referring to the attached drawings other than FIG. 1A. Preferred embodiments preferably include: (a) the specific software design and workflow methodology providing the user interface for point-of-care charge capture and patient tracking, (b) Internet (or ASP)-server based exchange, storage, parsing, authentication, audit trail creation, and analytic functionality, and (c) the methods whereby (a) and (b) are conjoined in such a way as to produce a seamless flow of information from user to device, from portable device to Internet server, from Internet server to office billing system, and from office or hospital systems back through the server system to the portable device, in compliance with HIPAA (as used herein, “HIPAA” means the Health Insurance Portability and Accountability Act of 1996, and its subsequent modifications, which governs the privacy of electronic medical records) and reimbursement standards published by national standards organizations and recognized by the federal government referred to herein as CPT (Current Procedural Terminology) and ICD (International Classification of Disease).

General Workflow Provide by New Art of The Preferred Embodiment

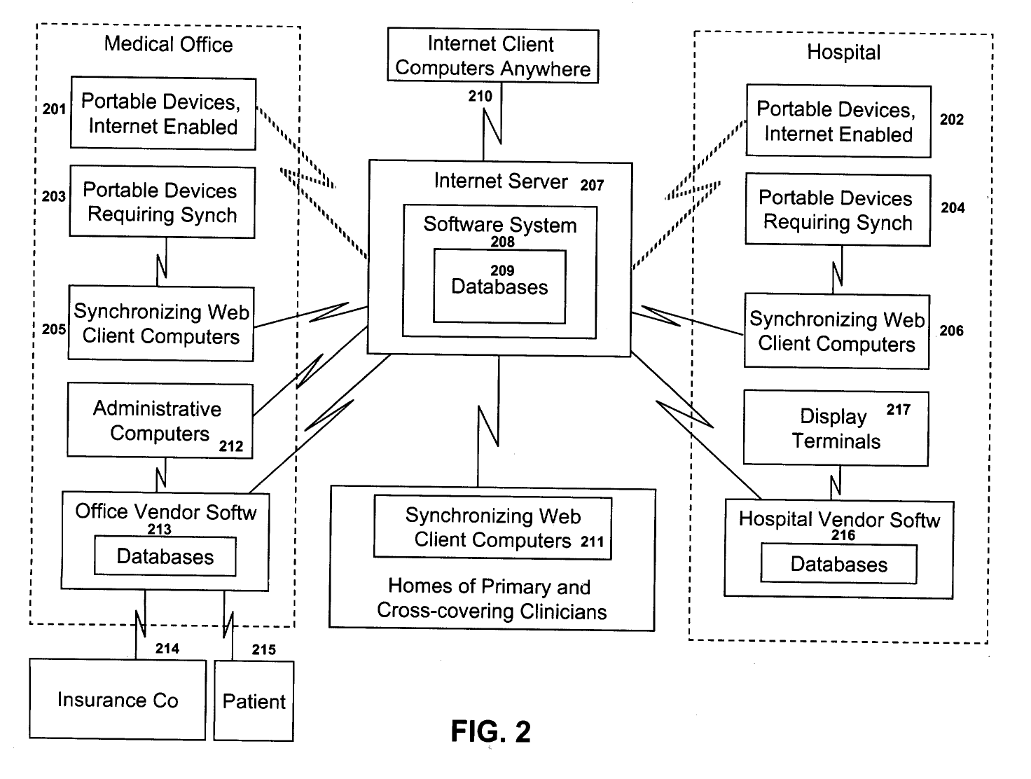

With reference now to FIGS. 1B and 2, the preferred embodiment alters the manner of workflow so that clean data is directly delivered 108 to the portable device 201-204 (or Internet application service provider, ASP 206) from either an office 213 or hospital 216 data system already containing necessary demographic and insurance data elements; where available, additional information such as medication listings, laboratory results, and transcribed history and physical examination findings may also be conveyed to the portable device to assist in management of the patient.

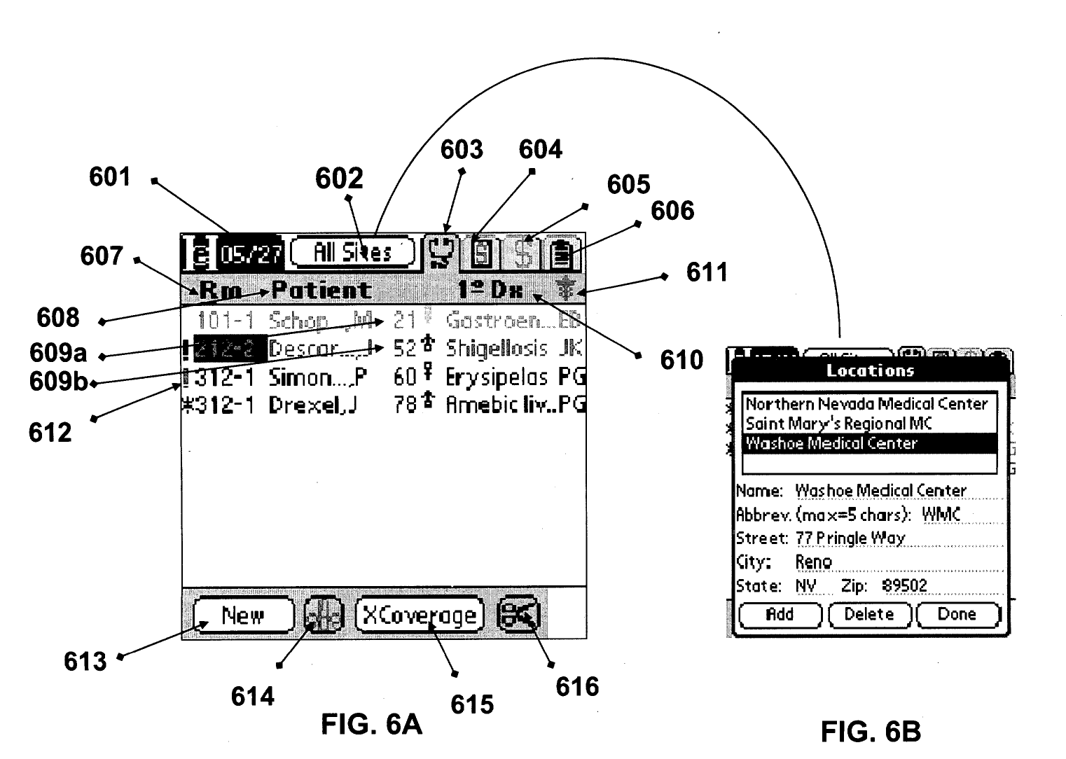

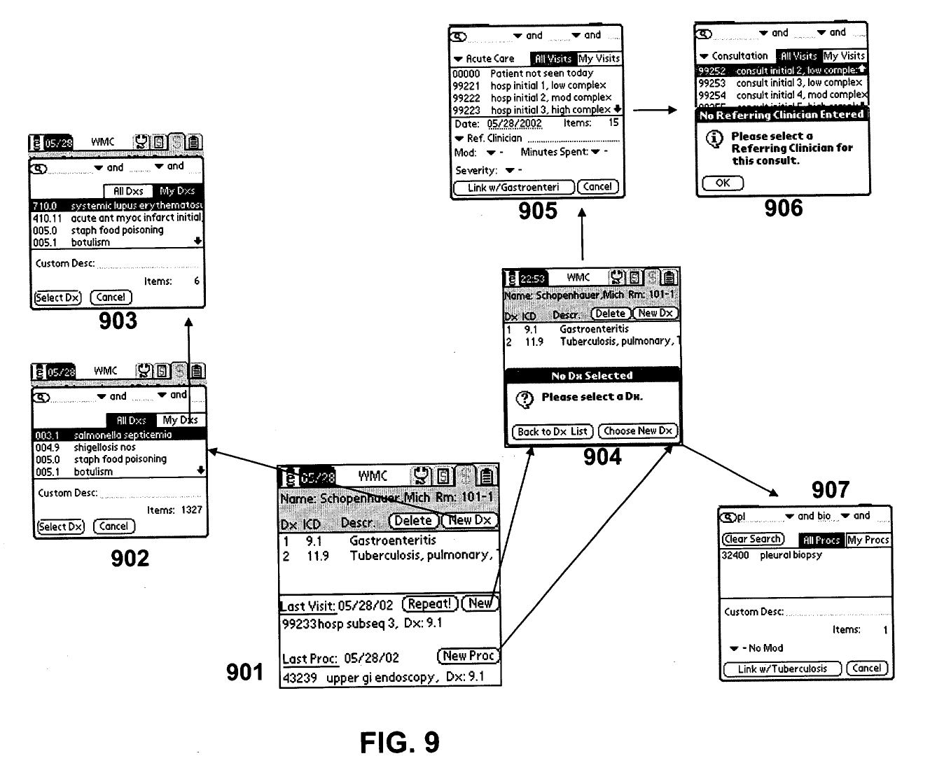

As the clinician (meaning physician or other health care provider) visits each patient, he/she holds the portable device 201-204, touches a button that powers on and usually directly opens the software application of the preferred embodiment, enters a HIPAA-compliant authenticating password (which is set to be required at certain intervals), then 109 taps on the patient's name in a table list followed by taps on diagnostic, visit and procedural codes, and, for new consultations, taps on a selection from a list of referring clinicians (see also FIGS. 6, 9); the clinical optionally enters new or revised clinical data for the purpose of tracking, reporting notes, or handing off patients to cross-covering associates.

The clinician proceeds to visit subsequent patients and likewise tap on combinations of codes, and automatically transfers all accumulated charge and clinical data at the time of synchronization of the portable device with a desktop computer 205, 206, 211 (typically at the end of each shift) or by wireless Internet connection 201, 202 (after each charge is entered).

The aforementioned synchronization on a desktop computer causes the activation of an executable program (a DLL) that extracts patient reports from the portable device, saves them to a desktop 205, 206, 211 file location for backup purposes, then transmits 110 the report by secure connection to the Internet-based server system of the preferred embodiment.

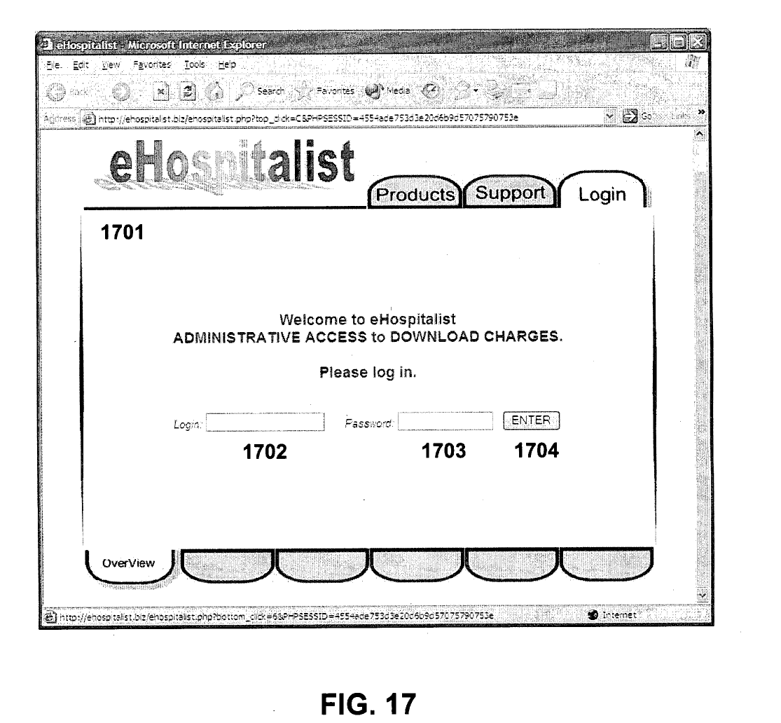

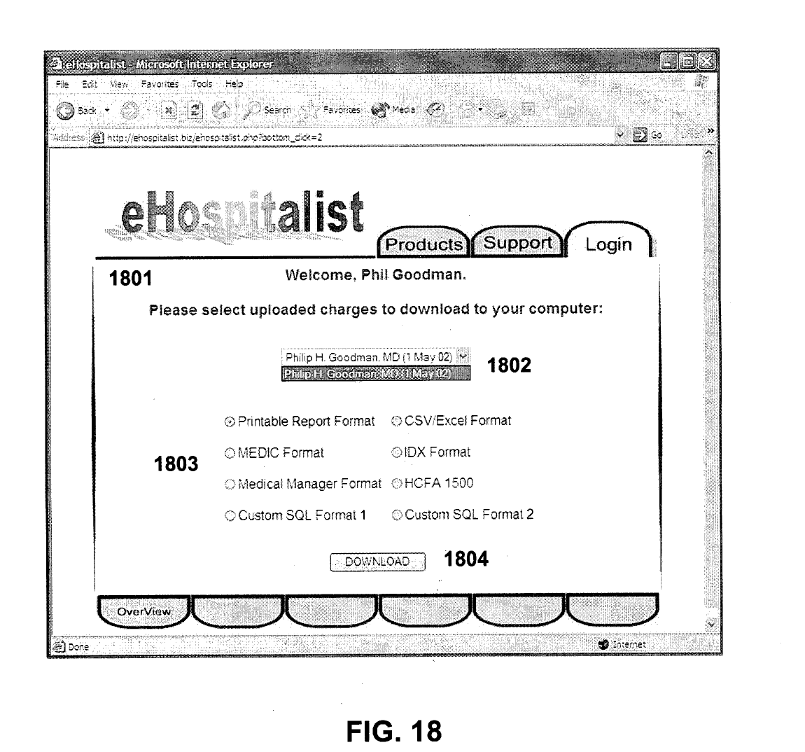

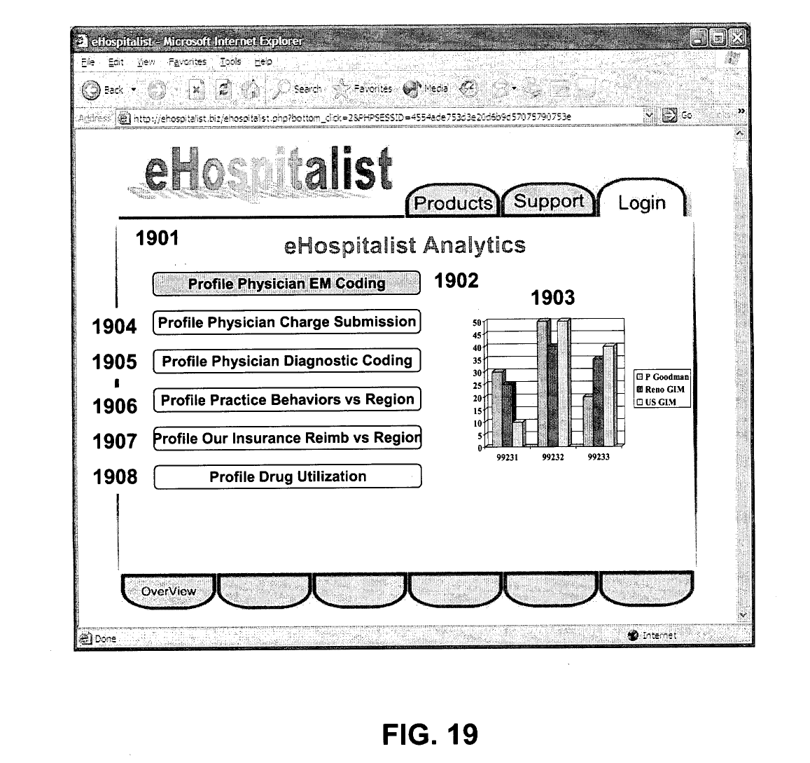

Upon receipt of the aforementioned report data, the Internet-based server system 111, 207-209 decrypts the file, parses the contents for navigation and accumulation of information, saves the contents in a structured relational database, and transfers a subset of the record stripped of patient identifiers to a database maintained for that purpose 113; an automated e-mail is sent to a designated office billing manager 212 as notification that a new charge report is available for download; for convenience, the e-mail contains a clickable link that can open the default Internet browser and link to the appropriate web page of the preferred embodiment (see also FIGS. 17, 18), enabling the manager to download a charge report formatted according to the needs of the local office billing system 112, 213-215.

The clinician may hand-off lists of patients containing clinical data and to-do messages by direct beaming between portable devices 201-204; alternatively, read-only access can be granted to associates for viewing during periods cross-coverage using any Internet-enabled computer system with a world wide web browser 210, 211.

An independent analytic system 209 tracks entries into the cumulative database free of patient identifiers for the purpose of reporting either in real-time or upon authenticated query, such trends as per-clinician performance in coding levels, timeliness of submission, length of stay (hospital) or duration or frequency of visits (office), diagnosis code mixtures, patient load, procedural distribution; these trends are normalized as a function of similar accumulated data on clinicians using the preferred embodiment with similar practices in the region and nationally, and may thus be used 114 to improve the efficiency and quality of care rendered by that practice

Details of the Portable Device

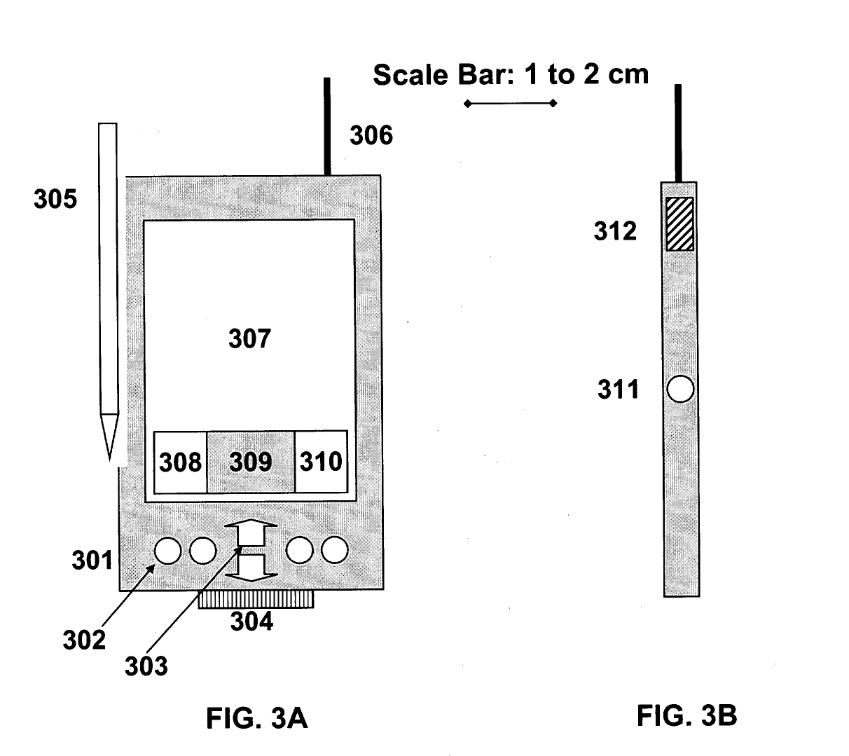

With reference now to FIGS. 3A and 3B, many companies have long marketed hand held computers, commonly referred to as palmtops or personal digital assistants (PDAs) such as the “Palm Tungsten C” by Palm, Inc. PDA's are characterized by light weight (typically under 12 ounces and most typically under 8 ounces) and small profile 301, so that they comfortably fit in a pocket, purse, or belt clip and can be held securely in one hand. PDAs are typically activated by pushing on a hard button 302, 311, which may be user-configured to directly open a software application; other hard buttons 303 are used to change screen contrast or navigate through extended screens of information. The PDA screen 307 is usually touch-sensitive, and is most reliably activated by a stylus 305 often held in a channel within the case of the device; once activated, touch sensitive “soft” buttons 308, 310 provide additional navigational shortcuts, and touch sensitive pattern-recognition algorithms are employed to convert various strokes on a designated area of the screen 309 into text and numbers within fields of the main screen display. The PDA is often synchronized (and the batteries may be charged) by physical connection to a conventional “docking” device connected to a desktop computer, or alternatively may synchronize with a computer using an infrared communication port 312. One or more PDAs may be equipped with a radio frequency transceiver capable of accessing the Internet without intermediary synchronization with a desktop computer; such devices usually have a visible antenna 306 and may also serve as a cellular phone or other wireless communications vehicle.

The applicants believe that, in the context of the hospital processes explained herein, PDA's and portable computing devices in particular can be more advantageously utilized. Most preferably and as an example, in the present systems and methods PDAs are adapted to maintain lists of patients and codes for E&M and procedural services, and the hospital-practicing physician can use the PDA to document, at the point-of-care, the rendering of such services linked to appropriate diagnoses “on the fly”. The ability to “click” or “tap” on familiar medical phrases, and have PDA-based software transcribe these designated phrases in acceptable E&M and procedural billing codes, can result in a more rapid and reliable means of capturing charges. Although patient identifiers and demographic data can be manually entered by the physician, synchronized downloads from home, office, or hospitals personal computers substitute for the process. Because a patient is often hospitalized for days to weeks, electronic medical record software can be incorporated with the PDA application to maintain and track clinical and charge information on a daily basis during the period of hospitalization. This PDA application should therefore also carry over, from day to day, tasks yet to be completed, as well as instructions and information for cross-covering physicians. Furthermore, the accumulated charge information is automatically delivered to the billing office by subsequent synchronization, ideally through the Internet, using secure hosted services. At the same time, information and instructions intended for cross-covering colleagues can be delivered to those persons via the Internet (and by automated download to their PDAs at the time of their next synchronization).

Security Management

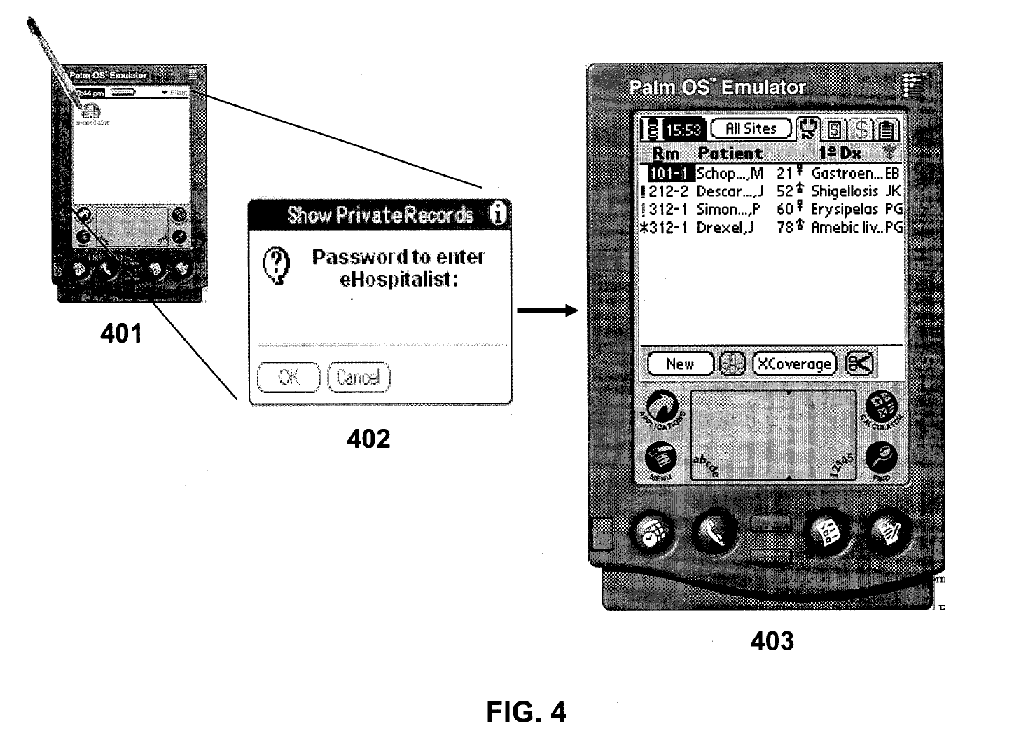

With reference now to FIG. 4, access control can utilize password entry for accessing the PDA-based application 401-403; in compliance with HIPAA, the frequency of such password requirement is either with every reactivation of the software of the preferred embodiment, or at such intervals as would not interfere with the usage of the device, but in any event not less frequently than daily. In compliance with HIPAA, the preferred embodiment includes private-key encryption using triple-DES or RSA technology for local storage of all patient-related data on the PDA, synchronized desktop computer, and the Internet server system of the preferred embodiment. A second encryption is applied during the process of uploading and downloading between the Internet server system and the synchronizing PC or a PDA that directly accesses the Internet.

The Internet (or possibly private ASP) server system maintains an “access authorization” database, whose contents are established by query of the registered user, and whose entry is validated by two technicians certified to operate the systems of the preferred embodiment; this authorization database established multiple levels of access including read-only and read-and-write for specific fields. All transactions conducted with the Internet server system are warehoused in an “audit trail” database system, comprising information about authenticated users and attempts lacking authentication, dates and times, and data resources involved; a management system enables reporting on this audit trail on routine periodic basis to a designated practice manager, and to federal authorities upon certified written request.

Point-of-Care Functionality of the Preferred Embodiment

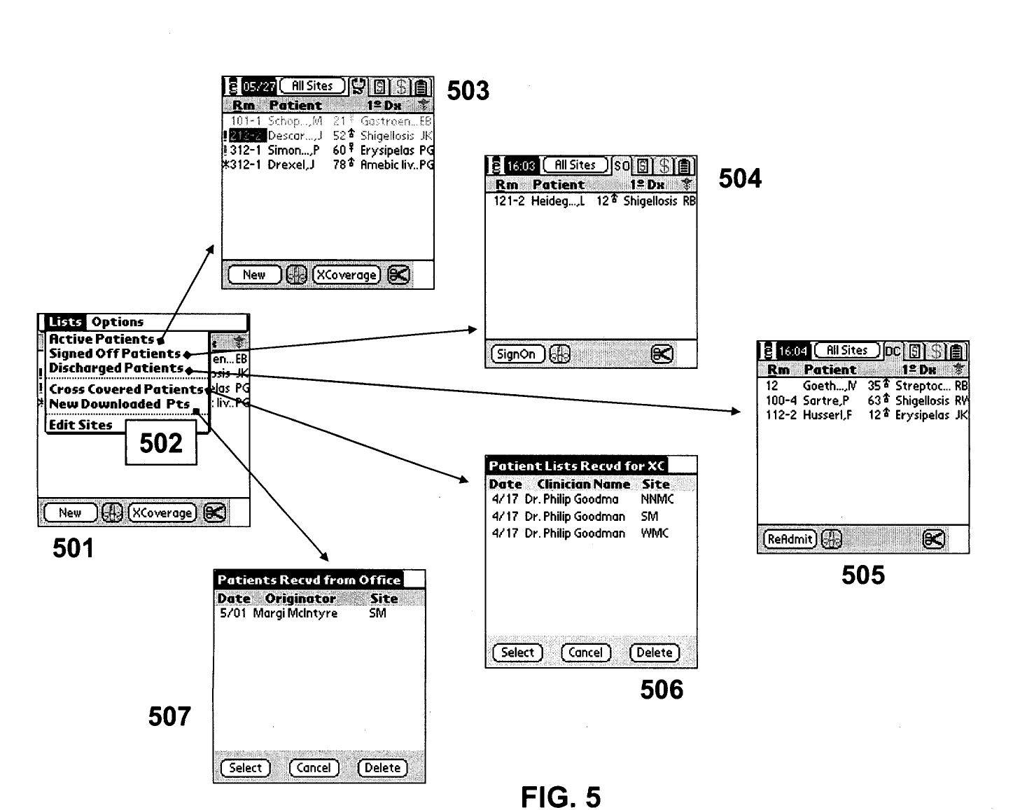

With reference now to FIGS. 5-15, upon activation of the software preferred embodiment running on the PDA or ASP, the user encounters a graphical emulation of the visual layout of office or hospital charts. This interface and associated database structure is coded using CodeWarrior C, the preferred C-language authoring tool for the Palm OS.

One of the aforementioned interface components is the utility of separate listings 502, or views, of active patients to be seen that day 503, of patients cared primarily by other clinicians but whose information is available for cross-coverage access at any hour of the day 506, of patients who have been discharged from the hospital or office practice 505, of patients on whom a clinician has consulted by now at least temporarily signs off 504, and of patients whom the clinician or staff member has transmitted to the portable device from the Internet server-based system but who have yet to be accepted into active status 507.

An additional interface component is a selectable menu indicating the site at which the patients are to be seen 602, the contents of which may be provided as a regional database as part of the product, but which may be manually edited as well (FIG. 6B). Additional interface components include a “rounds list” table (FIG. 6) displaying a listing patients 609 which the user can select according to hospital or office site 602 and sort by room number 607, name 608, diagnosis 610, or the initials 611 of a clinician closely associated with the care of a patient. Coloration and font style variation is used to indicate charge-status of a patient (gray if correct codes were linked that day) 609a, sufficient provision of administrative data (red if incomplete) 609b, and alert for duplicate last names (bold font). Shortcuts are implemented to minimize the number of stylus taps utilized to accomplish the care of the patient, including a) quick tap on a patient's line to move immediately to the superbill view, b) holding the stylus for a fraction of a second to move to directly the chart view, c) tapping the leftmost column of a patient listing to move to the to-do view, and d) two taps in total to leave the active rounding list, duplicate the diagnosis and visit codes linked the previous day's, then automatically return to the active rounding list.

Another of the aforementioned interface components is the provision of active buttons to manually add a new patient 613, delete, discharge, or sign-off a consulted patient 616, send the current list of patients to another clinicians PDA for cross-coverage 615, and an intuitive button to add a task to do 614. Additional interface components include a global display of alternating date and time 601 for reference in writing chart orders and notes, a array of tabs along upper margin, resembling similar features in a paper chart system, which upon touch by stylus or fingertip causes navigation to a major subset of functionalities which include the rounds list views 603, charge-generating “superbill” view 605, charge history view 604, and clinical chart view 606.

Tapping on the aforementioned charge history tab 604 brings up a display 703, 801 of a patients with new charges not yet reported out of the portable device and, by single-tap initiation of a dialog box 802, selects specific charges for review. Also from the of the report generation display 801, a single-tap allows the user to initiate a) generation of a human-readable charge report for printing at the time of synchronization with a computer, b) generation of a charge report in a encrypted structured format that is transmitted to the Internet (or ASP) server at the time either of wired synchronization or of wireless Internet connection, or c) infrared or radio frequency transmission 804 of a human-readable charge report to a printer with corresponding wireless reception capability; in all such sequences, the user is offered a dialog in which to entered a text note to the billing administrator to accompany the charge report so generated 803.

Tapping on the aforementioned superbill tab 605 brings a) a display 901 of read-only name and room number fields, b) a list of major diagnoses or problems, dynamically reordered by dragging with a stylus over the touch-sensitive screen, and editable by tapping “Delete” or “New” touch-sensitive buttons, c) a display of the last set of linked visit (evaluation and management procedure) and diagnostic codes, updateable by tapping “Repeat” or “New” touch-sensitive buttons, and d) a display of the last set of linked non-visit procedure and diagnostic codes, updateable by tapping a “New” touch-sensitive button.

Tapping on the superbill view's “New Dx” button opens a “specify diagnosis dialog” 902, 903 displaying a list of diagnostic codes and a multi-term Boolean query 907 dialog for searching from two alternate menus, one displaying all available codes provided as an electronic database 902, the other showing “My Codes” 903, which are those codes selected during previous operation of the system by that user, in descending order of frequency; the user may alternatively manually enter a “Custom Description” for the patient's problem for purposes of describing an uncommon condition or a problem not definable as a diagnosis.

Tapping on the superbill view's “New Visit” button first checks that the user first selected, by tapping, an established diagnosis, or by selecting from an alternative list of diagnoses not heretofore listed as a diagnosis 904; this ensures that a diagnosis code will always be associated with a subsequently chosen visit code; the “New” visit dialog 905 is dismissed either by tapping a “Link” button to record the association, or a “Cancel” button (in which case no linkage occurs); an additional rule 906 ensures that if the visit codes a new consultation, that the name of the referring clinician is selected from a list.

Tapping on the aforementioned clinical chart tab 606 brings up alternative views representative of administrative and clinical data 705, history and physical examination 706, drug lists 707, progress notes 708 including laboratory results, hospital or office discharge instructions 709, and to-do notices 710 with time-sensitive alarms set by the user, a cross-covering clinician, an administrator, or the system itself as a way of notification.

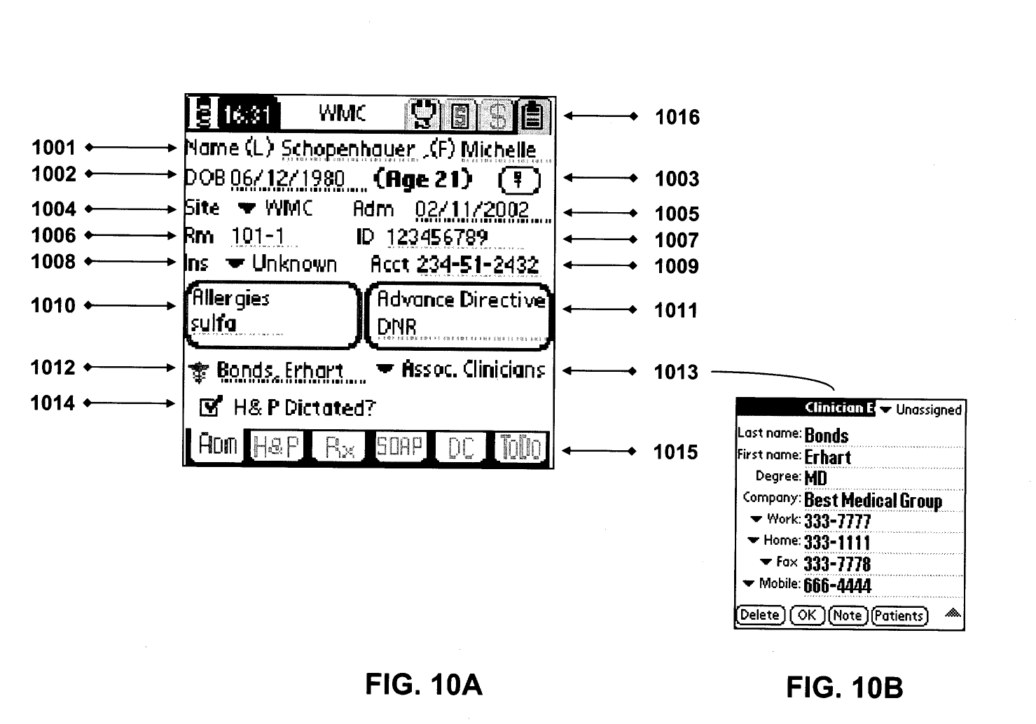

The administrative and clinical data screen (FIG. 10A) contains fields for the name 1001, date of birth 1002, gender 1003, hospital or office site 1004, date of admission or entry 1005, room 1006, unique identifier 1007, insurer 1008, and other practice-determined account or identifier 1009 such as a social security number; the preferred embodiment is implemented with user-determined options for validation of the presence and content (for example, that a hospital or office record identifier is an alphanumeric string of a prespecified length); the user is allowed to override such setting, but such action causes the “rounds view” character text of that patient's name to be colorized red 609b as a reminder.

The administrative and clinical data screen (FIG. 10A), because of potentially overriding importance, allows automated or manual entry of clinical data relating to medical allergies 1010 and advance directives 1011; if content exists in the allergy field, it is subsequently colorized with a red border, and if content exists in the advance directives field, it is subsequently colorized with a blue border to draw the attending of the user, and thereby lesson the likelihood of a mistake in medical orders; the user can readily navigate to other top-tab functions 1016 or bottom chart tab screens 1015.

The administrative and clinical data screen (FIG. 10A), also provides access 1013 for editing and selecting the name of another clinician 1012 who is associated with the care of that patient; the initials of that clinician are displayed in the “rounds view” listing of that patient 611; a database (FIG. 10B) of associated clinicians is independently maintained by automated download for the Internet server or by manual entry by the user; this clinician database contains name, professional degree, specialty, address and contact information; additionally, an embedded database is maintained wherein all patients tracked over time by a user and associated with another clinician as well are saved for later review (this listing is invoked from within that associated clinicians record).

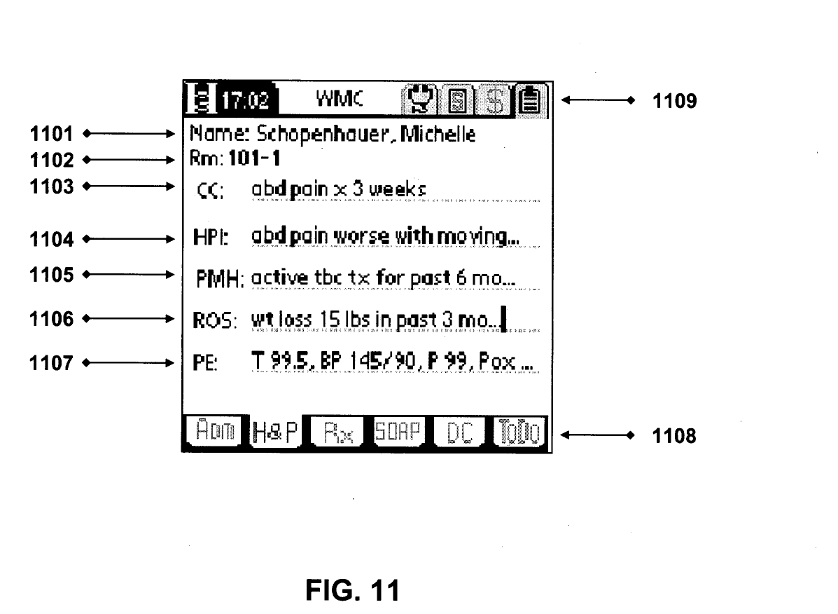

The “history and physical examination findings” screen (FIG. 11) allows for automated Internet download by the method or user-entered alphanumeric text reflecting the clinician's initial medical findings upon first evaluating a patient (read-only name 1101 and room 1102); templates of standard phrases are provided to minimize the time and effort of manual entry of the following text fields: chief complaint 1103, history of present illness 1104, past medical history 1105, review of systems 1106, and physical examination 1107; from this view the user can readily navigate to other top-tab functions 1109 or bottom chart tab screens 1108.

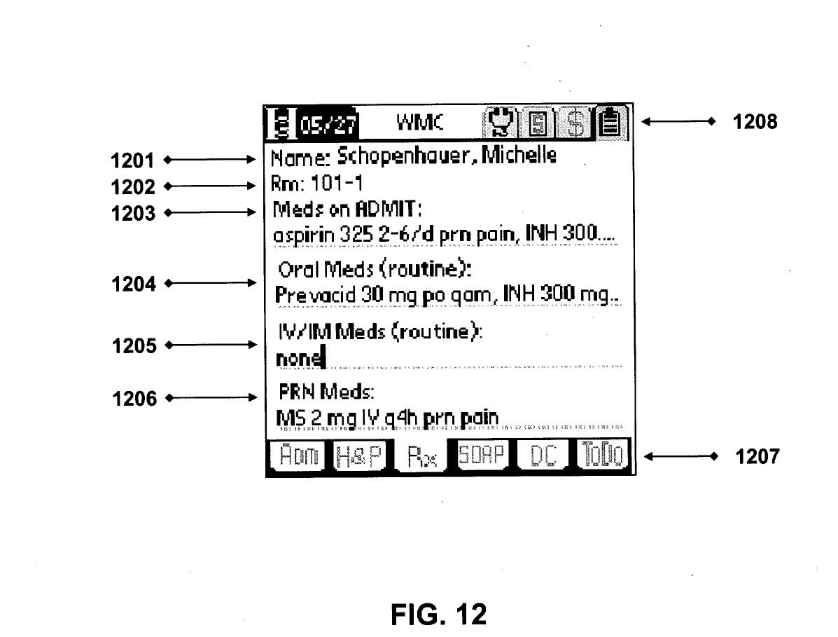

The “drugs” listing (FIG. 12) for a patient (with read-only display of name 1201 and room number 1202) allows automated Internet download or user-entered alphanumeric text reflecting a) drugs used by the patient through the office prior to a hospital admission 1203, and b) scheduled oral 1204, scheduled parenteral 1205, and as-needed 1206 drugs in use during a period of hospitalization should that occur; drugs and dosing routes are selectable from menus listing common choices, to minimize the time and effort of manual entry; from this view the user can readily navigate to other top-tab functions 1208 or bottom chart tab screens 1207.

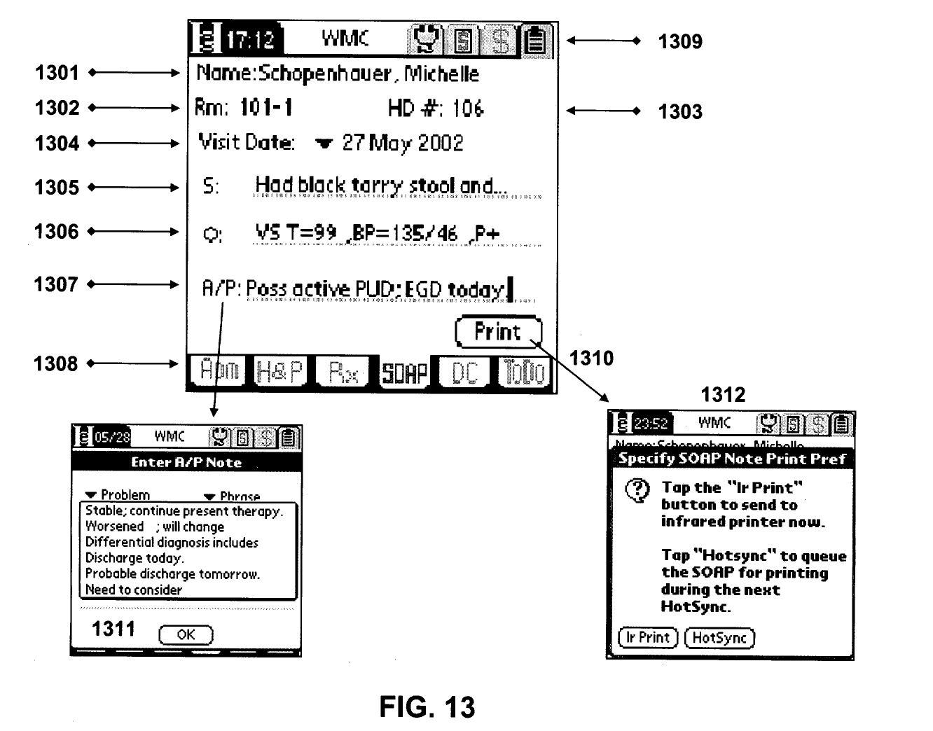

The “SOAP progress notes” screen (FIG. 13, wherein SOAP stands for Subjective 1305, Objective 1306, Assessment and Plan 1307) allows user-entered alphanumeric text reflecting a specific date's 1304 observations (with read-only display of name 1301 and room number 1302) made by the clinician; template text 1311 is selectable from menus listing common choices, to minimize the time and effort of manual entry; these SOAP notes may be printed 1310 for signature and chart placement by either infrared or at the time of hotsync 1312; and will automatically accompany bills to insurers to document the effort associated with that episode of care; from this view the user can readily navigate to other top-tab functions 1309 or bottom chart tab screens 1308.

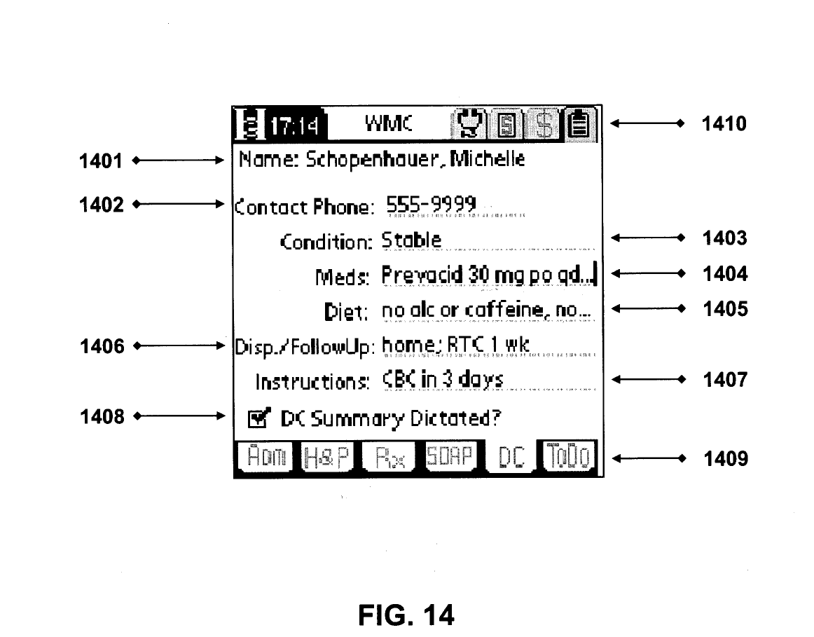

The “discharge data” screen (FIG. 14) for a patient (with read-only display of name 1401 and room number 1402) allows user-entered alphanumeric text reflecting the clinician's final recommendations on office practice release or hospital discharge for: a) contact phone 1402 for follow-up conversations, b) medical condition 1403, c) medications 1404, d) diet 1405, e) disposition and follow-up plans 1406, and f) other instructions 1407 as well as a self-reminder as to whether the discharge has been dictated 1408; these text fields are supplied with templates of standard phrases to minimize the time and effort of manual entry; from this view the user can readily navigate to other top-tab functions 1410 or bottom chart tab screens 1409.

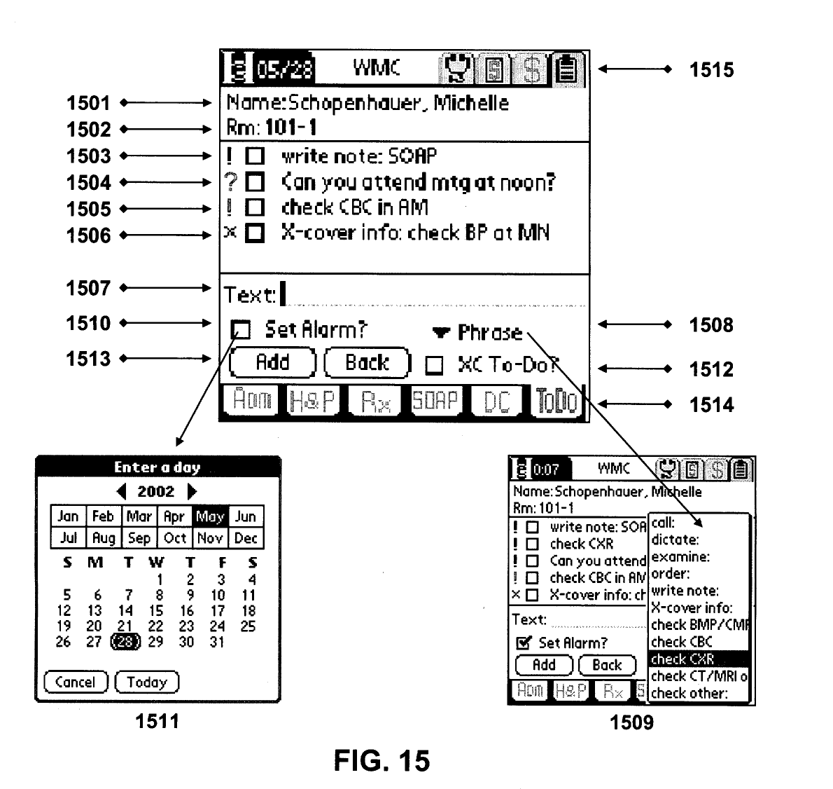

The “To-Do list” screen (FIG. 15) for a patient (with read-only display of name 1501 and room number 1502) allows the user to be graphically notified in the “rounds view” 612 concurrently (black exclamation point 1503) or at a future date 1511 (red exclamation point 1505) of tasks to be completed or office or system event of which to be aware (green question mark 1504); additionally, this list is used to enter notes for cross-covering clinicians 1512 (“X” symbol 1506) about relevant concerns or tasks yet to be accomplished, and likewise to notify the primary user after-the-fact that a cross-covering clinician undertook some activity about which the primary user should be aware; after entering 1507 (using editable template text for efficiency 1508, 1509) or viewing a to-do item, the user is returned by a single tap on a touch-sensitive button 1513 to the “rounds view”; from the to-do screen the user can readily navigate to other top-tab functions 1515 or bottom chart tab screens 1514.

Details of the Internet (or VPN) Server Functionality:

The Internet server-side computer software applications provide multiple functionalities subserved by multiple independent relational databases for the applications described below. In this regard, as noted in several instances above, a Virtual Private Network (VPN) may be utilized, in a fashion well known to those skilled in the art (including without limitation potentially utilizing transport protocols such as the Internet Protocol), rather than, or in conjunction with, the “Internet.” It is therefore to be understood that the Internet and Internet server-side components discussed herein (including without limitation as referenced in the claims above) may alternatively or in addition include, at least in part and possibly in their entirety, a “VPN” or “VPN server-side components.”

One Internet server-side computer software application provides “read-only viewing” of patient clinical information by the primary clinician or authenticated cross-covering clinicians; this information is viewable through any computer connected to the Internet running a browser client application, such as a computer at an hospital, office, or home location; the server maintains an audit trail of all such access into a database accessible only by system administrators with the highest level of clearance; the interface of this application resembles that on the PDA.

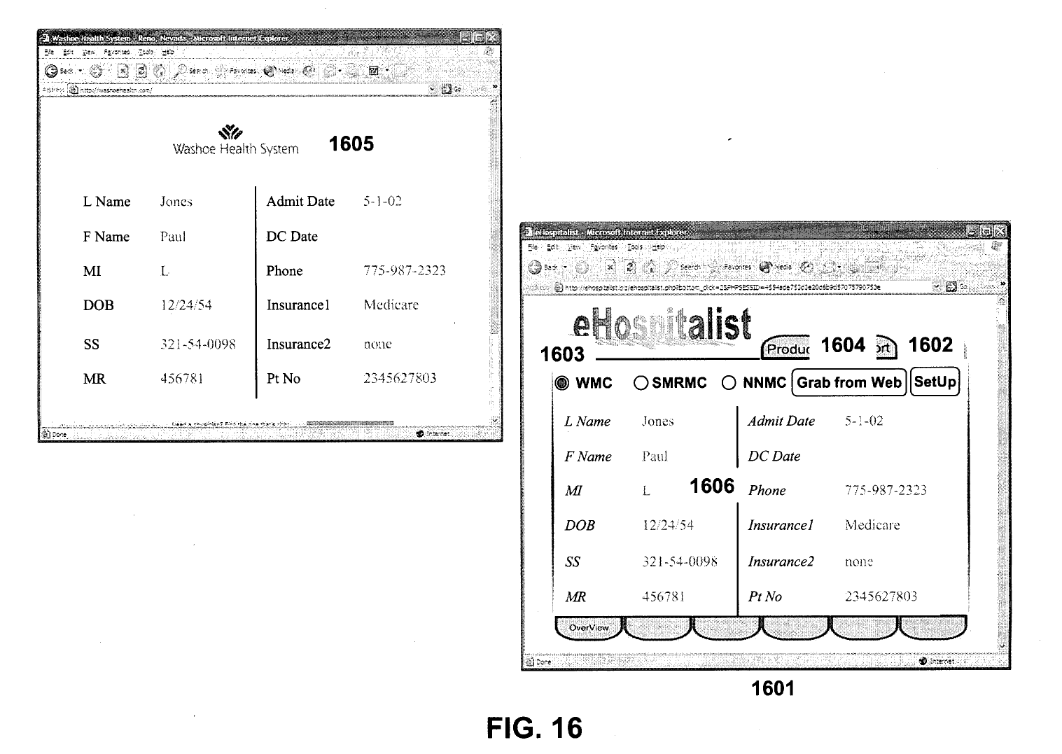

Another Internet server-side computer software application provides a “new patient entry” (FIG. 16) interface in which clinicians or their office staff may manually enter by keyboard or cut-and-paste operation, or by macro facility 1604, 1602 to automate such actions, using any computer connected simultaneously to an (office or hospital) database containing the relevant patient information 1605 and to the Internet server 1603 by way of a browser client application 1601, for the purpose of downloading relevant patient information as clean data for reconciliation with patient data managed on the portable device.

Another Internet server-side computer software application creates a secure electronic “socket connection” to office 213 or hospital 216 databases, where available, for the purpose of downloading relevant patient information as clean data for reconciliation with patient data managed on the portable device. Yet another Internet server-side computer software application subserves an “application service provider” (ASP) interface offering essentially all functionality represented on the portable device as described heretofore; this ASP functionality is accessible through any computer connected to the Internet 210 running a browser client application. A still further Internet server-side computer software application exchanges and accumulates clinical information from portable devices or Internet client systems affiliated with the preferred embodiments.

In addition, an Internet server-side computer software application provides “charge report relay and notification” as follows: a) upon wired or wireless hotsync of a portable device, unreported charges are passed as a report by way of the Internet to the server, b) server parses the report for billing doctor identifiers, (c) server sends e-mail to server-registered billing administrator, indicating availability of report, providing a direct Internet browser link in body of e-mail message, d) server web page 1701 allows billing administrator to log in 1702-1704, and from another web page 1801 select from uploaded user reports 1802, designate final format 1803, and download the report 1804 over the Internet to administrator's computer.

Another family of Internet server-side computer software applications provide analytic functions (“analytics”) by way of the web 1901 that can be used to maintain quality control in the processes of patient care and billing of medical charges, involving an electronic database system that performs comparisons using data stripped of identifying information; such comparison include but are not limited to the following by way of textual and graphic displays: a) temporal trends of billing code levels for new and established patients 1902 graphically 1903 by billing clinician, compared with other clinicians in practice and other groups in same specialty and or by diagnosis, b) cumulative diagnosis code mixtures 1905 by billing clinician, compared with other clinicians in practice and other groups, c) timeliness of charge report submission 1904, to detect patterns of gaps with real-time notification of administrative staff upon the occurrence of gaps unanticipated by historical patterns and pre-set alarm values, d) length of hospital stay, or number of office visits within a specified window of time, 1906 of a clinician user's patients as a function of diagnoses, severity of illness measures, medical specialty and demographics of the clinician, and geographic region, and e) office or hospital drug prescribing patterns 1908 of a clinician user's patients as a function of diagnoses, severity of illness measures, medical specialty and demographics of the clinician, and geographic region.

Finally, another Internet server-side computer analytic software application provides an interface for entry of certain insurance payer reimbursement and contractual information by a practice, for analytic comparison of such performances with that of similar practices in the same region and across multiple regions served by that payer; comparisons are made using a database generated from similar payer information from other practices stripped of practice and patient identifying information.

Details of the Handheld Database Model:

The handheld model consists of the following database tables:

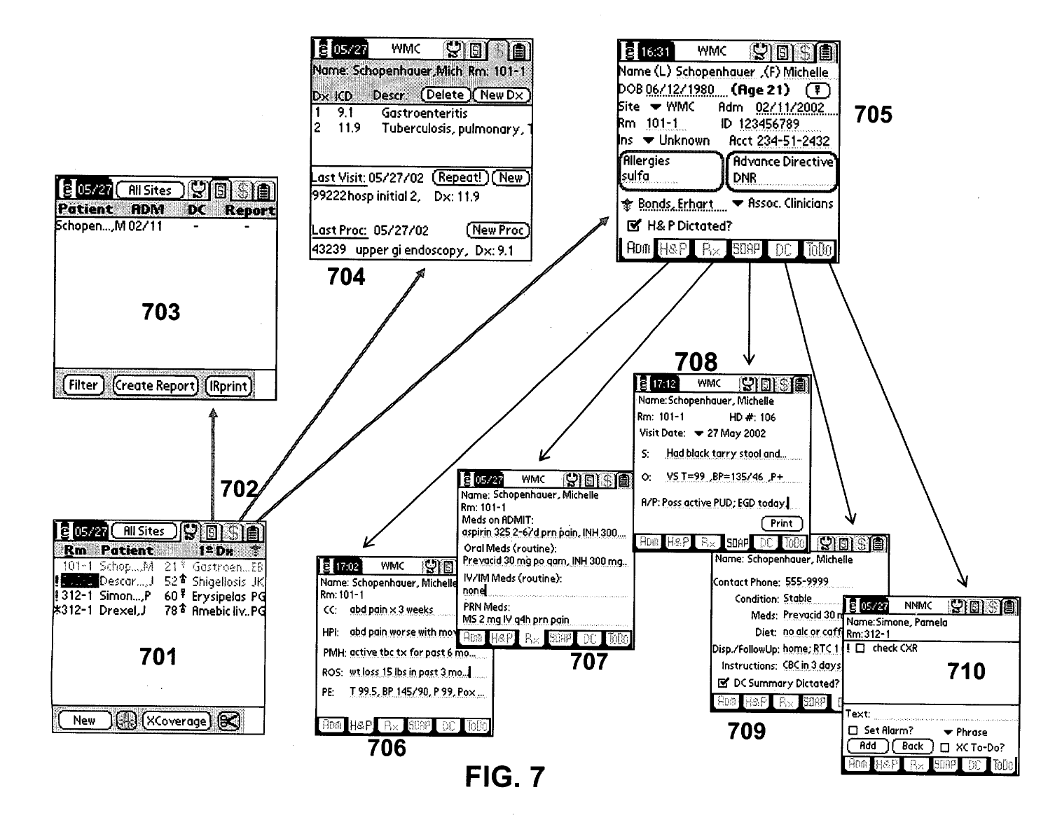

Patients—Patients are the central record type around which the application revolves, the handheld user is mainly interested in tracking and billing these entities. The list of patients are visible in the main Rounds view 503 and in various single patient views as depicted in FIG. 7.

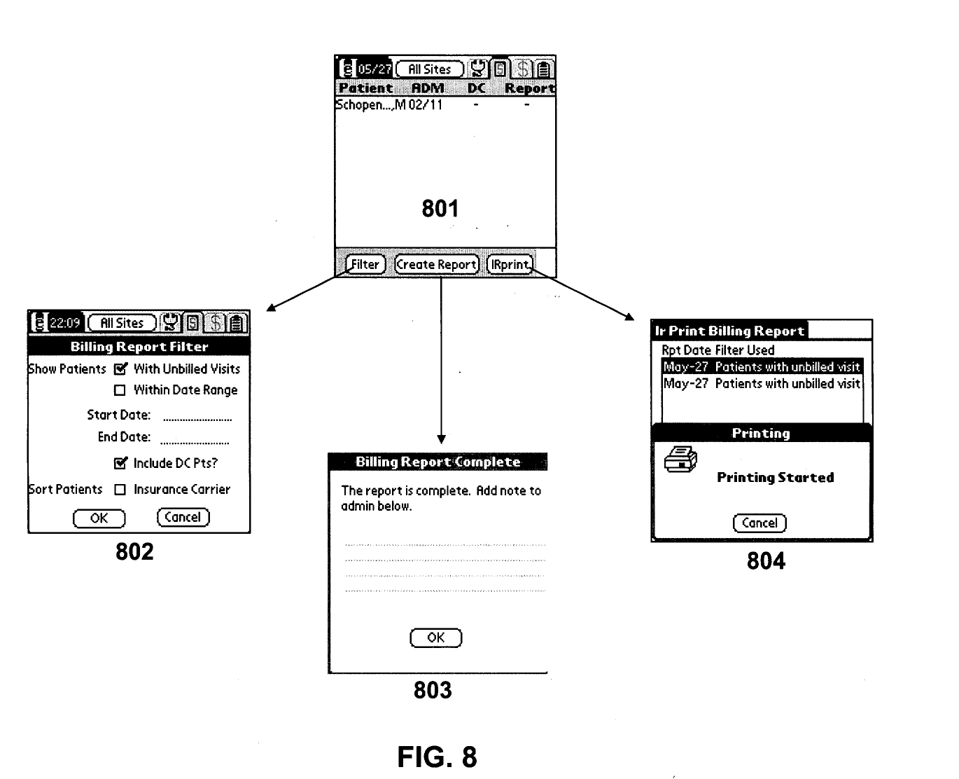

Visits and Procedures—The user adds visits or procedures on a daily basis to their active patients, see FIG. 9. These records are like line items on an invoice. When the user generates a billing report (FIG. 8) these visits and procedures compose the detailed body of the report.

Procedure Codes—Procedure Code records contain code and description strings. The codes are the accepted identifier used by the medical billing systems as defined by the Common Procedural Terminology (CPT). The description field accompanies its code in the Procedure Codes form as depicted in 907.

Procedure Specialties—A Procedure Code is assigned to at least one Procedure Specialty. The selection of a specialty allows the user to filter and therefore find Procedure Codes more readily.

Visit Codes—Visit Code records contain code and description strings. The codes are the accepted identifier used by the medical billing systems as defined by the Common Procedural Terminology (CPT), more specifically they represent a list of acceptable Evaluation and Management codes assignable for services rendered in various medical settings.

EM Categories—Evaluation and Management categories are used to filter the available Visit Codes for selection, see 905.

Visit and Procedure Modifiers—Modifiers describe additional effort performed during a visit or procedure. When assigned by the user while adding a visit or procedure, see FIG. 9, they further document the service provided. Rules enforce the allowable modifier assignable to the selected Visit or Procedure Code, see 905 and 907.

Dx Codes—Diagnosis Codes (ICD9) records are composed of code and description strings. They are assigned to patients and must be linked with any visit or procedure added for a patient, see 902 and 903.

Sites—Site records are for storing information about the facility in which care is provided such as a hospital or nursing home. Patients are assigned to a single site. FIG. 6B depicts the form for editing Site records.

To-Do's—A user can assign any number of tasks to be performed for a patient. The To-Do's database contains these associated record. To-Do's can be assigned to be completed by a specific date or not, see 710.

Clinicians—Associated clinicians are assigned to patients to allow the user to track referrals or primary caregivers as appropriate. Each patient can have up to three assigned associated clinicians. The Clinicians table is also used to lookup referring clinicians when required to do so, see 906.

Clinician Specialty—Clinicians can be categorized by specialty to aid in their lookup, see FIG. 10B.

Billing Reports—Reports are the collection of patients and their visits and procedures prepared in a static format for submission to the physician's administrative staff or billing service.

Cross Coverage Patients—These are patient records received from other physicians. They exist in a separate table available for review as depicted in 506. The physician can choose to accept these patients should they need to perform a service for them.

Cross Coverage Visits—These records are associated to Cross Coverage Patients and contain information relevant to continuing their care. The physician is able to review SOAP notes entered by the physician for whom they are covering.

Cross Coverage To-Do's—These records are associated to Cross Coverage Patients and contain information relevant to continuing their care. The physician is able to review To-Do items created by the physician for whom they are covering,

Downloaded Patients—These are patient records received from a physician's office. They exist in a separate table available for review as depicted in 507. In the normal workflow, the physician will choose to accept these patients before performing any services for them.

Details of the Server Database Model:

The server database model consists of the following database tables:

TUser—The core table for user identity and authentication. There are two distinct user types, Clinicians and their Clerks. All users can log into the website assuming they authenticate themselves as required. Each user type has an assigned security level that controls which data they can see on the web. Clerks must be associated to one or more Clinicians within a practice.

TClinician—A user who is a clinician has an associated record in this table to further identify them to the web application. Clinicians can log into the website from a browser or connect via their synchronized PC or or connect via their wireless PDA. The Clinician and their attributes control their clerks' ability to use the web application.

TUserAuthentication—Security characteristics of every user who has access to the web application.

TRole—A reference table of roles that can be assigned to users.

TRelUserRole—A bridge table to allow a user to be assigned to one or more roles.

TClinicianSpecialty—A reference table of specialties assignable to Clinicians.

TPractice—A table of practice names and their identifying characteristics. A practice record will be added for a new Clinician as needed.

TPracticeType—A reference table of practice types.

TPracticeSite—A table of practice facilities for a practice. A practice will consist of one or more practice sites.

TPracticeSiteType—A reference table that describes the Practice Site, usually indicates whether the site is a business office or care facility.

TState—A reference table of U.S. states.

TFReport—The container for reports created on the PDA and uploaded via synchronization with a handheld. Reports are the static output of patients and their visits and procedures used for submission to the billing system.

TTransaction—A record of activity within the web application. All user activity is date and time stamped and recorded in real time for audit purposes.

TTransactionTypes—A reference table of transaction types.

Further Aspects of the Preferred Business Method Pertaining to the Clinician Workflow at the Point of Care:

As disclosed above, the system and methods of the preferred embodiment can substantively impact the workflow and satisfaction of the clinician using the system, based on the change in mode of operation from the prior art [055-061] above and FIG. 1A to [062-069] above and FIG. 1B.

The preferred embodiment is most preferably deployed in the hospital setting, although it may be widely deployed in other health care environments and used by a wide variety of health care providers, not just physicians. In the hospital setting, a clinician starting a day of rounding on patients typically has a roster identifying the patients with their room numbers. This typically is obtained by carrying over the list of patients from the previous day, with edits according to admissions or discharges that occurred on the day prior. The edits and reprinting are either performed manually by the clinician or an office staff member (hand written or computer generated). In some hospitals the clinician may access and print the roster directly, but still keep a personal confirmatory listing, as hospital listings do not reliably track new admissions or transfers to a particular clinician, because the admitting or attending name is often erroneously assigned by an admission clerk. The present preferred embodiment alleviates this repeated hand written or office-generated listing by maintaining on the handheld and server systems, an ongoing, accurate listing of patients, locations, activity, and to-do reminders. The result is, preferably, the alleviation of the substantial psychological and time-consuming burden of obtaining a list by going to an office or obtaining a fax to update the list, and then copy over lists of activity and to-do reminders and resulting plans.

As the clinician attends to each patient, he or she preferably now refers to the handheld device's screen to determine where to next round. Because the electronic format of the preferred embodiment permits sorting of the active patient list in ascending or descending order by room number and type of diagnosis, and because the text font color is muted (typically made gray) after a valid visit code is entered, the clinician can now more efficiently round than by repeatedly revising a rounding strategy based on viewing a fixed paper listing, as was the case with the prior art. The clinician follows an intuitive interface to tap-to-charge and record relevant information on the PDA.

A major burden of time and effort on the parts of both the clinician and his or her office staff often is the generation of a legible charge record and conveyance of that record to the office billing system. Prior art typically involves a clinician deposit, fax, or verbal call in the record of all patient contacts including linked diagnoses for each visit and procedure (and referring clinician name with the visit is a response to a consultative request). The preferred embodiment alleviates those steps: at the time of synchronizing with an Internet enabled desktop computer (or by direct Internet communication in the case of Internet-enabled PDAs), all charges and associated information are silently transmitted to the Internet server of the preferred embodiment, and from there to the desktop of the office billing clerk.

Further Aspects of the Preferred Business Method Pertaining to the Office Workflow Revenue Model:

As disclosed above, the system and methods of the preferred embodiment can substantively impact the workflow of the office billing and management staff using the system, based on the change in mode of operation from the prior art [055-061] above and FIG. 1A to [062-069] above and FIG. 1B. Because charge-related records are automatically transmitted by way of the Internet server of the preferred embodiment to the desktop of the office billing clerk, there is substantial reduction in the staffing necessary to (1) telephone or page clinicians to remind them to turn in such records, (2) access in person or electronically hospital “face sheet” information and the chart itself to corroborate patient identification and correct coding combinations, and (3) manually enter charges from the paper records into the computerized office billing system.

The electronic transference of records from PDA to office system results additionally in shortened time to billing, reduced aging of accounts receivable (that is, earlier and increased revenue), and thereby profits to the medical practice. The real-time analytic functions, such as automatic notification of excessive gaps in transmission of records by a given doctor, also prevent missed opportunities to shorten the billing cycle.

Further Aspects of the Preferred Business Method Pertaining to the Practice Management Revenue Model:

The time-trended analytic functions described above in [113-114] enables the office administrative and medical directorship staff to perform continuous quality improvement of the care rendered, financial performance, and coding compliance of the participating clinicians. One instantiation of this process would be for the office administrator to access the Internet or ASP server and obtain a standardized profile of each clinician according to the server measures provided. This would be discussed in private interview format with each clinician, and way to improve performance developed and subsequently monitored. Another instantiation would be for the administrator to upload monthly financial reimbursement by patient or payer, and to periodically review the trended performance in comparison with other payers as a function of the case mix; this information would be brought to bear during periodic contract negotiations with the payers.

Again, it is to be understood that this section describes the applicants' preferred embodiments of the applicants' systems and methods of use and doing business. Other embodiments will be apparent to those skilled in the art from consideration of the specification and practice of the invention disclosed herein. It is intended that the specification and examples be considered as exemplary only, with a true scope and spirit of the invention being indicated by the claims as issued in connection with the application as well as all permitted equivalents.

What we claim is:

1. A method and system of the type potentially useable to track a plurality of patients during the course of their care by a health care practice, share patient data among users, and facilitate linkage of diagnostic or procedural codes preferably according to rules required for payment approval from a health care payer or other entity in connection with an encounter between a health care practitioner and a patient, comprising: an Internet-based server system in communication with a portable or Internet-connected client device for use at a point of patient care by the health care practitioner, the portable device comprising: a) memory for storing information that facilitates the health care practitioner's linkage of approved codes required for payment approval from the health care payer in connection with the encounter; b) an input mechanism for receiving input from a user at least during the encounter and at the point of care; and c) an output mechanism for providing output to the user at least during the encounter and at the point of care.

2. The system of claim 1 wherein the portable device comprises a processor, wherein the information stored in the memory includes instructions for execution by the processor, and wherein the information also includes data that represents the rules for proper linkage of diagnostic and procedural codes required for payment approval from at least one health care payer in connection with the encounter.

3. The system of claim 1 wherein the Internet-connected client device comprises a processor, wherein the information stored in the memory includes instructions for execution by the processor, and wherein the information also includes instructions to communicate as a client with an Internet-connected server.

4. The system of claim 1 wherein the Internet server comprises a processor, electronic memory and systems to back up the memory, wherein the information stored in the memory includes instructions for execution by the processor, and wherein the information also includes software instructions for the processing, storage, and transfer of data by way of electronic ports connected to the Internet.

5. The system of claim 2, wherein the portable device enables the user to enter, either manually or by download from the Internet server of claim 4, a patient's name, gender, date of birth, social security number, contact telephone number, and insurance identifiers; and in the case where applied to the care of hospitalized patients, additional elements include hospital admission date, hospital room number, and alphanumeric hospital identifier, where “hospital” refers to an acute short-term, long-term acute, rehabilitation, or nursing facility, or any environment in which a clinician bills for professional services outside of the confines of an established office practice.

6. The system of claim 2, wherein the portable device enables the user to enter, either manually or by download from the Internet server of claim 4, a patient's clinical information to include as a minimum a description of medical allergies and advance directive statements.

7. The system of claim 2, wherein the portable device enables the user to enter, either manually or by download from the Internet server of claim 4, a patient's background clinical information that may include listings of prehospital medications, established diagnoses, and reports of medical history and physical examination.

8. A method whereby the portable device of claim 2 provides an interface for the user to manually enter (by stylus touch-sensitive screens or keyboard functionality) a daily progress note containing a subjective, objective, assessment, and planning information about a patient.

9. The method of claim 8, wherein the daily progress note is generated by copying and appropriately editing prior template text so as to minimize the time and effort involved in manually entering such information.

10. The method of claim 8, wherein the daily progress note is saved in electronic memory for later report linkage to procedures rendered on the same calendar day.

11. The method of claim 8, wherein the daily progress note is printed from the portable device of claim 2 to a printing device by either infrared or wireless radio frequency communication, or by a larger computer system to which the portable device is from time to time electronically synchronized.

12. The method of claim 11, wherein the printed daily progress note is signed and entered into the chart of the patient to serve as a record of the clinician user's involvement in the patient's care on that day.

13. The system of claim 2, wherein the portable device enables the user to communicate information to the device that specifies at least one diagnosis for the patient.

14. The system of claim 2, wherein the portable device enables the user to communicate information to the device that specifies at least one health care procedure for the patient specifically linked to the primary diagnosis.

15. The system of claim 14, wherein the calendar date of the communicated information is linked to the specification.

16. The system of claim 14, wherein the health care procedure for the patient includes either an evaluation and management code or a technical procedural code to be applied to the interaction between the user and the patient.

17. The system of claim 16, wherein the health care procedure for the patient may include an approved modifier to the procedural code to be applied to the interaction between the user and the patient.

18. The system of claim 16, wherein the health care procedure for the patient may additionally require the linkage of the name of a referring clinician for certain evaluation and management service codes.

19. The system of claim 14, wherein the device responds to the linked diagnosis, procedures, and date by communicating information to the user that constitutes notice that the modifier is not in compliance with a rule required for payment approval by a health care payer in association with the encounter.

20. The system of claim 14, wherein the portable device requires the user to enter an alphanumeric string into an electronically displayed form, in order to gain access to any part of the other functionalities or data.

21. The system of claim 2, wherein the portable device transfers patient clinical information from the authenticated user to another authenticated user by means of either infrared or radio frequency transmission between the two owners' devices.

22. The system of claim 2, wherein the portable device transfers patient clinical information from the authenticated user to another authenticated user by means of the intermediary Internet server system of claim 4.

23. The systems of claim 21 used in the physical proximity of clinician users of the portable devices of claim 2.

24. A method of presenting graphical and textual information, of the type useable to facilitate the care of a hospitalized or office patient using the system of claim 2, wherein the software application operating on the portable device presents a branching sequence of screens (viewable windows) that display informative fields and responds to the user's requests for subsequently displayed information.

25. The method of claim 24, wherein an easily accessible menu provides access to “lists” of patients and to “preferences” dialogs that allow the user to customize the functionality of the major features of the application running on the portable device.

26. The method of claim 24, wherein the global screen features include a repetitively alternating display of data and time, for immediate reference by the user for documentation and ordering in a patient's chart.

27. The method of claim 24, wherein the global screen features a set of tabs along the upper margin, resembling similar features in a paper chart system, which upon touch by stylus or fingertip causes navigation to a major subset of functionalities which include the rounds list views, superbill view, charge history view, and clinical chart view.

28. The method of claim 24, wherein the rounds list view is a table displaying a listing of patients which the user can select according to hospital or office site and sort by room number, name, diagnosis, or the initials of a clinician closely associated with the care of a patient.

29. The method of claim 28, wherein an easily accessible menu of claim 25 causes the display of one the following lists to appear in the rounds list view: a) “active list” patients who may be charged for procedures, b) “discharged list” patients whom the user has moved from “active” status either explicitly by touch-screen activation, or implicitly by assigning a procedural code corresponding to discharge, c) “signed-off list” patients whom the user has moved from “active” status explicitly by touch-screen activation because ongoing consultation is no longer required, d) “cross-covered” patients whose clinical data is accessible from a file conveyed to the user according to the method of claim 21 or 22, and e) “new downloaded” patients whose clinical data is accessible from a file conveyed to the user by download from the Internet by the system of claim 4.

30. The method of claim 24, wherein the software application maintains a listing of hospital or office site name, abbreviated name, address, phone and facsimile numbers, and Internet web address, which is modified either by user editing or by upload of an established database from the Internet server of claim 4 by wireless connection or at the time of synchronization with a larger computer system.

31. The method of claim 30, wherein a touch-screen selectable graphic region in a “rounds list view” allows the user to select for viewing those patients located at one or all of the hospital or office sites.

32. The method of claim 24, wherein touch-screen selectable graphic regions within the “rounds list view” allows the user with one tap to initiate a) infrared or radio frequency handoff of the clinical data belonging to currently viewed patients to a trusted, cross-covering clinician, b) add a new patient, or c) delete, discharge, or sign-off from the care of a patient; a single tap on a “to do” icon to the left of patient's name moves the user to a related “to do listing” described subsequently; additionally, short-cut features are incorporated such as brief-tapping on a row containing a patient's name as a surrogate for clicking on the “superbill view” (claim 35), and hold-tapping for several tenths of a second as a surrogate for clicking on the “chart view” (claim 50)

33. The method of claim 24, wherein a “charge history view” offers a display of those patients with new charges not yet reported out of the portable device and, by single-tap initiation of dialog boxes, select specific charges for review in detail.

34. The method of claim 33, wherein touch-screen selectable graphic regions within the “charge history view” allows the user with one tap to initiate a) review or edit of existing charges on the PDA.

35. The method of claim 24, wherein a “superbill view” offers a) a display of read-only name and room number fields, b) a list of major diagnoses or problems, dynamically reordered by dragging with a stylus over the touch-sensitive screen, and editable by tapping “Delete” or “New” touch-sensitive buttons, c) a display of the last set of linked visit (evaluation and management procedure) and diagnostic codes, updateable by tapping “Repeat” or “New” touch-sensitive buttons, and d) a display of the last set of linked non-visit procedure and diagnostic codes, updateable by tapping a “New” touch-sensitive button.

36. The method of claim 35, wherein the “New” diagnosis touch-sensitive button opens a “specify diagnosis dialog” displaying a list of diagnostic codes and a multi-term Boolean query dialog for searching that listing; the user may alternatively manually enter a “Custom Description” for the patient's problem for purposes of describing an uncommon condition or a problem not definable as a diagnosis.

37. The method of claim 36, wherein a list of diagnostic codes is available from two alternate menus, one displaying all available codes provided as an electronic database, the other showing “My Codes”, which are those codes selected during previous operation of the system by that user, in descending order of frequency.

38. The method of claim 35, wherein the “New” visit touch-sensitive button opens a “specify visit dialog” displaying a list of evaluation and management; the user may alter the default date of the visit to conform to a previous date on which entry had not been completed; the user may optionally manually enter an from automated-entry menus the following: visit modifier codes, severity of illness scale ratings, time spent in rendering care during that day, and the name of a referring clinician (this may be required by the system for certain consultation visit codes).

39. The method of claim 38, wherein the user upon entering the “New” visit dialog is required to have first selected, by tapping, on an established diagnosis listed according to the method of claim 35, or by selecting from an alternative list of diagnoses not heretofore listed as a diagnosis; this ensures that a diagnosis code will always be associated with a subsequently chosen visit code; the “New” visit dialog is dismissed either by tapping a “Link” button to record the association, or a “Cancel” button (in which case no linkage occurs).

40. The method of claim 35, wherein the “New” procedure touch-sensitive button opens a “specify procedure dialog” displaying a list of Common Procedural Terminology (CPT) codes, selectable by specialty, and a multi-term Boolean query dialog for searching that listing; the user may alter the default date of the procedure to conform to a previous date on which entry had not been completed; the user may optionally tap-select from automated-entry menus a set of modifier codes subsetted dynamically for the procedure code selected in the list; the user may alternatively manually enter a “Custom Description” for the procedure for purposes of describing an uncommon procedure.

41. The method of claim 24, wherein a “chart view” offers a window which comprises simultaneously-viewable tabs along the bottom, reminiscent of similar tabs found on many hospital and office charts; tapping on touch-sensitive tabs brings to the front view one of the following screens typically containing: a) “admission data”, b) “history and physical examination findings”, c) “drugs”, d) “SOAP progress notes”, e) “discharge data”, and f) “to-do list”.

42. The method of claim 41, wherein the screen containing “administrative data” of claim 5 is implemented with user-determined options for validation of the presence and content of each field (for example, that a hospital or office record identifier is alphanumeric string of a prespecified length); the user is allowed to override such setting, but such action causes the “rounds view” character text of that patient's name to be colorized red as a reminder.

43. The method of claim 41, wherein the screen containing “administrative data” of claim 5 is implemented, because of overriding importance, to allow automated or manual entry of clinical data relating to medical allergies and advance directives; if content exists in the allergy field, it is subsequently colorized with a red border, and if content exists in the advance directives field, it is subsequently colorized with a blue border to draw the attending of the user, and thereby lessen the likelihood of a mistake in medical orders.

44. The method of claim 41, wherein the screen containing “administrative data” of claim 5 also provides access for editing and selecting the name of another clinician who is associated with the care of that patient; the initials of that clinician are displayed in the “rounds view” listing of that patient as in the method of claim 28.

45. The method of claim 44, wherein a database of associated clinicians is independently maintained by automated download from the web server of method 4 or by manual entry by the user; this clinician database contains name, professional degree, specialty, address and contact information; additionally, an embedded database is maintained wherein all patients tracked over time by a user and associated with another clinician as well are saved for later review (this listing is invoked from within that associated clinicians record).

46. The method of claim 41, wherein the screen containing “history and physical examination findings” allows automated Internet download by the method of claim 4 or user-entered alphanumeric text reflecting the clinician's initial medical findings upon first evaluating a patient; these text fields are supplied with templates of standard phrases to minimize the time and effort of manual entry.

47. The method of claim 41, wherein the screen containing “drugs” listing allows automated Internet download by the method of claim 4 or user-entered alphanumeric text reflecting a) drugs used by the patient through the office prior to a hospital admission, and b) drugs in use during a period of hospitalization should that occur; drugs and dosing routes are selectable from menus listing common choices, to minimize the time and effort of manual entry.

48. The method of claim 41, wherein the screen containing “SOAP progress notes” (wherein SOAP stands for Subjective, Objective, Assessment, and Plan) allows user-entered alphanumeric text reflecting daily observations made by the clinician; template text is selectable from menus listing common choices, to minimize the time and effort of manual entry; these SOAP notes may be printed for signature and chart placement per the method of claim 12; and will automatically accompany bills to insurers to document the effort associated with that episode of care.

49. The method of claim 41, wherein the screen containing “discharge data” allows user-entered alphanumeric text reflecting the clinician's final recommendations on office practice release or hospital discharge for: a) contact phone for follow-up conversations, b) medical condition, c) medications, d) diet, e) disposition and follow-up plans, and f) other instructions; these text fields are supplied with templates of standard phrases to minimize the time and effort of manual entry.

50. The method of claim 41, wherein the screen containing a “to-do list” allows the user to be graphically notified in the “rounds view” concurrently or at a future date of tasks to be completed or event of which to be aware; additionally, this list is used to enter notes for cross-covering clinicians about relevant concerns or tasks yet to be accomplished, and likewise to notify the primary user after-the-fact that a cross-covering clinician undertook some activity about which the primary user should be aware; after entering or viewing a “to-do” item, the user is returned by a single tap on a touch-sensitive button to the “rounds view”.

51. The system of claim 3, wherein Internet server-side computer software applications provide “read-only viewing” of patient clinical information by the primary clinician or authenticated cross-covering clinicians; this information is viewable through any computer connected to the Internet running a browser client application, such as a computer at an hospital, office, or home location; the server maintains an audit trail of all such access into a database accessible only by system administrators with the highest level of clearance.

52. The method of claim 3, wherein Internet server-side computer software applications provide a “new patient entry” interface in which clinicians or their office staff may manually enter by keyboard or cut-and-paste operation, using any computer connected simultaneously to an (office or hospital) database containing the relevant patient information and to the web server by way of a browser client application, for the purpose of downloading relevant patient information as clean data for reconciliation with patient data managed on the portable device.

53. The method of claim 3, wherein Internet server-side computer software applications create a secure electronic “socket connection” to office or hospital databases, where available, for the purpose of downloading relevant patient information as clean data for reconciliation with patient data managed on the portable device.

54. The system of claim 3, wherein server-side computer software subserve an “application service provider” (ASP) interface offering essentially all functionality represented on the portable device as described in the methods of claims 5 through 50; this ASP functionality is accessible through any computer connected to the Internet running a browser client application.

55. The system of claim 4, wherein an Internet-connected server exchanges and accumulates clinical information from portable devices or Internet client systems affiliated with the system.

56. The method of claim 55, wherein an Internet-connected server provides “charge report relay and notification” as follows: a) upon wired or wireless hotsync of a portable device, unreported charges are passed as a report by way of the Internet to the server, b) server parses the report for billing doctor identifiers, (c) server sends e-mail to server-registered billing administrator, indicating availability of report, providing a direct Internet browser link in body of e-mail message, d) server web page allows billing administrator to log in, designate format, and download the report over the Internet to administrator's computer.

57. The method of claim 55, wherein an Internet-connected server provides analytic functions (“analytics”) that can be used to maintain quality control in the processes of patient care and billing of medical charges.

58. The method of claim 57, wherein the Internet server system maintains an electronic database system that performs comparisons using data stripped of identifying information; such comparison include but are not limited to the following by way of textual and graphic displays: a) temporal trends of billing code levels for new and established patients, by billing clinician, compared with other clinicians in practice and other groups in same specialty and or by diagnosis, b) cumulative diagnosis code mixtures by billing clinician, compared with other clinicians in practice and other groups, c) timeliness of charge report submission, to detect patterns of gaps with real-time notification of administrative staff upon the occurrence of gaps unanticipated by historical patterns and pre-set alarm values, d) length of hospital stay, or number of office visits within a specified window of time, of a clinician user's patients as a function of diagnoses, severity of illness measures, medical specialty and demographics of the clinician, and geographic region, and e) office or hospital drug prescribing patterns of a clinician user's patients as a function of diagnoses, severity of illness measures, medical specialty and demographics of the clinician, and geographic region.

59. The method of claim 57, wherein the Internet server system maintains an interface for entry of certain insurance payer reimbursement and contractual information by a practice, for analytic comparison of such performances with that of similar practices in the same region and across multiple regions served by that payer; comparisons are made using a database generated from similar payer information from other practices stripped of practice and patient identifying information.
